(19) United States
(12) Patent Application Publication
(10) Pub. No.: US 2018/0081441 A1
(43) Pub. Date: Mar. 22, 2018

(54) Integrated Haptic Output and Touch Input System

(71) Applicant: Apple Inc., Cupertino, CA (US)

(72) Inventors: James E. Pedder, Thame (GB); Supratik Datta, Sunnyvale, CA (US); Karan Jain, Cupertino, CA (US); Jui-Ming Yang, Sunnyvale, CA (US); Pavan O. Gupta, Belmont, CA (US); Robert W. Rumford, Santa Clara, CA (US); Wei Lin, Santa Clara, CA (US); Xiaofan Niu, Campbell, CA (US); Xiaonan Wen, San Jose, CA (US)

(21) Appl. No.: 15/621,966

(22) Filed: Jun. 13, 2017

Related U.S. Application Data
(60) Provisional application No. 62/397,299, filed on Sep. 20, 2016.
(60) Provisional application No. 62/397,171, filed on Sep. 20, 2016.

(51) Int. Cl. G06F 3/01; G06F 3/041; G06F 3/044

(52) U.S. Cl. CPC G06F 3/016; G06F 3/0412; G06F 3/044; G06F 3/0414

(57) ABSTRACT

An electronic device is configured to provide localized haptic feedback to a user on one or more regions or sections of a surface of the electronic device. The localized haptic feedback is provided by an array of piezoelectric haptic actuators below the surface of the electronic device. Actuators within the array of piezoelectric haptic actuators are separately controllable by a control circuit layer. The control circuit layer includes control circuitry, a master flexible circuit which passes between rows of actuators, and an array of slave flexible circuits. Each slave flexible circuit is connected to the master flexible circuit and an actuator. In further examples, the array of piezoelectric haptic actuators provides a unified structure for detecting touch and force inputs.

### CROSS-REFERENCE TO RELATED APPLICATIONS

This application claims the benefit under 35 U.S.C. § 119(e) of U.S. Provisional Patent Application No. 62/397,299, filed on Sep. 20, 2016, and entitled “Design and Process For Low Cost Haptic Actuator Assembly,” and U.S. Provisional Patent Application No. 62/397,171, filed on Sep. 20, 2016, and entitled, “A Piezoelectric-Based Unified Method For Force And Touch Sensing,” the contents of which are incorporated by reference as if fully disclosed herein.

### FIELD

Embodiments described herein relate generally to electronic devices having a haptic output system integrated with a touch input system.

### BACKGROUND

An electronic device can incorporate a haptic output system and a touch input system. A haptic output system uses the sense of touch to convey information to a user and a touch input system receives input from that user. Conventionally, a haptic output system and a touch input are separate systems, each requiring a dedicated volume within a housing of the electronic device that incorporates them.

### SUMMARY

Certain embodiments described herein relate to an electronic device that is configured to provide localized haptic feedback to a user on one or more surfaces of the electronic device. The localized haptic feedback is provided by an array of piezoelectric haptic actuators, which are controlled by a flexible circuit assembly. In some embodiments, an electronic device includes a cover sheet, a display below the cover sheet, a chassis below the display, and array of piezoelectric actuators below the chassis. Typically, the array of piezoelectric actuators is attached to the chassis.

In certain embodiments, a flexible circuit assembly is electrically connected to each of the array of piezoelectric actuators. The flexible circuit assembly includes a master flexible circuit, a first slave flexible circuit, and a second slave flexible circuit. The master flexible circuit is positioned along a row of piezoelectric actuators and connected to the first and second slave flexible circuits. The master flexible circuit may be connected to each slave flexible circuit along the row. The first slave flexible circuit is electrically connected to a first piezoelectric actuator and the second slave flexible circuit is electrically connected to a second piezoelectric actuator.

In some examples, the flexible circuit assembly is also connected to control circuitry configured to generate control signals. The control signals induce a voltage across a piezoelectric substrate in each piezoelectric actuator, causing the piezoelectric actuator to compress and/or deflect to produce haptic output at the cover sheet.

Further embodiments described herein relate to a method for connecting an array of piezoelectric haptic actuators to control circuitry. Such methods include the operations of applying an electrically conductive bonding agent to a master flex member and, thereafter, aligning a first and a second slave flex member with the master flex member. The first and second slave flex members are bonded to the master flex member.

In some embodiments, the electrically conductive bonding agent is a solder paste, and the bonding operation includes heating the first slave flex member, the second slave flex member, and the master flex member in a reflow oven. In some embodiments, the method further includes the operations of applying an electrically conductive bonding agent to the first slave flex member, and bonding the first piezoelectric haptic actuator to the first slave flex member. The first piezoelectric haptic actuator may be bonded to the first slave flex member by an anisotropic conductive film or an isotropic conductive film.

Further embodiments described herein relate to an electronic device having a unified piezoelectric-based sensor for detecting force and touch inputs. The electronic device includes an enclosure, a display positioned within the enclosure, an input region positioned within the enclosure, and a sensor structure positioned below the input region. The sensor structure includes a piezoelectric substrate and a sensing layer comprising a plurality of electrodes. The sensor structure is configured to detect a location of a touch within the user input region and to estimate an amount of force corresponding to the touch.

Another example embodiment may be a method of detecting a touch and estimating an amount of force of the touch. The method includes the steps of detecting the touch with a sensor structure comprising a piezoelectric substrate, detecting an electrical response caused by compression of the piezoelectric substrate with the sensor structure, estimating the amount of force using the electrical response, and outputting a signal indicating the estimated amount of force.

Still another embodiment may be a user input device. The user input device includes a cover sheet comprising a user input surface and a sensor structure positioned below the cover sheet. The sensor structure includes a piezoelectric substrate and a sensing layer comprising a plurality of electrodes. The sensor structure is configured to detect a location of a touch on the user input surface and to estimate an amount of force corresponding to the touch.

### BRIEF DESCRIPTION OF THE DRAWINGS

The disclosure will be readily understood by the following detailed description in conjunction with the accompanying drawings, wherein like reference numerals designate like structural elements.

FIG. 1A depicts an example of an electronic device that can provide localized deflection of a surface.

FIG. 1B depicts an example of an electronic device that can provide localized deflection of a surface, illustrating a control circuit layer.

FIG. 2A depicts a cross-sectional view of an example of the electronic device taken along line A-A in FIG. 1B.

FIG. 2B depicts a cross-sectional view of an example of the electronic device taken along line A-A in FIG. 1B, illustrating the electronic device when a piezoelectric haptic actuator is actuated.

FIG. 3A depicts an example of the control circuit layer over an array of piezoelectric haptic actuators.

FIG. 3B depicts another example of the control circuit layer over an array of piezoelectric haptic actuators.

FIG. 4A depicts a cross-sectional view of an example haptic actuator module of the electronic device taken along line B-B in FIG. 3A.

FIG. 4B depicts a cross-sectional view of another example haptic actuator module of the electronic device taken along line B-B in FIG. 3A.

FIG. 5A depicts a master control flex and slave control flex according to a first example embodiment.

FIG. 5B depicts a top view of a piezoelectric haptic actuator according to a first example embodiment.

FIG. 5C depicts a cross-sectional view of the piezoelectric haptic actuator of FIG. 5B, taken along line C-C.

FIG. 5D depicts a master control flex and slave control flex according to a second example embodiment.

FIG. 5E depicts a top view of a piezoelectric haptic actuator according to a second example embodiment.

FIG. 5F depicts a cross-sectional view of the piezoelectric haptic actuator of FIG. 5E, taken along line D-D.

FIG. 5G depicts a master control flex and slave control flex according to a third example embodiment.

FIG. 5H depicts a top view of a piezoelectric haptic actuator according to a third example embodiment.

FIG. 5J depicts a cross-sectional view of the piezoelectric haptic actuator of FIG. 5H, taken along line E-E.

FIG. 6A depicts a top view of a slave control flex split across a top and bottom of a piezoelectric haptic actuator.

FIG. 6B depicts a cross-sectional view of a haptic actuator module incorporating the slave control flex according to the embodiment of FIG. 6A.

FIG. 7A depicts an example method of attaching a slave control flex to a master control flex.

FIG. 7B depicts another example method of attaching a slave control flex to a master control flex.

FIG. 8 depicts a laptop computer with a trackpad incorporating an array of piezoelectric haptic actuators.

FIG. 9 depicts a cellular telephone with a display incorporating an array of piezoelectric haptic actuators.

FIG. 10 depicts a flow diagram illustrating a method for coupling together components of a control circuit layer.

FIG. 11 depicts example components of an electronic device in accordance with the embodiments described herein.

FIG. 12 depicts an isometric view of an electronic device having a sensor structure according to the present invention.

FIG. 13 depicts a simplified cross-sectional view of the electronic device of FIG. 12 taken along line F-F, illustrating a stack-up of the sensor structure.

FIG. 14 depicts a simplified cross-sectional view of the electronic device of FIG. 12 taken along line G-G, illustrating a sensing layer of the sensor structure.

FIG. 15 depicts a simplified cross-sectional view of the electronic device of FIG. 12 taken along line G-G illustrating the sensing layer of the sensor structure in response to detection of a touch.

FIG. 16 depicts a simplified cross-sectional view of the electronic device of FIG. 12 taken along line F-F, illustrating a stack-up of the sensor structure in response to an applied force.

FIG. 17 depicts a simplified cross-sectional view of the electronic device of FIG. 12 taken along line F-F, illustrating a stack-up of the sensor structure producing a haptic output.

FIG. 18 depicts an example system diagram of an electronic device according to the present invention.

The use of cross-hatching or shading in the accompanying figures is generally provided to clarify the boundaries between adjacent elements and also to facilitate legibility of the figures. Accordingly, neither the presence nor the absence of cross-hatching or shading conveys or indicates any preference or requirement for particular materials, material properties, element proportions, element dimensions, commonalities of similarly illustrated elements, or any other characteristic, attribute, or property for any element illustrated in the accompanying figures.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Reference will now be made in detail to representative embodiments illustrated in the accompanying drawings. It should be understood that the following descriptions are not intended to limit the embodiments to one preferred embodiment. To the contrary, they are intended to cover alternatives, modifications, and equivalents as can be included within the spirit and scope of the described embodiments as defined by the appended claims.

The following disclosure relates to an electronic device that is configured to provide localized haptic feedback to a user on one or more surfaces of the electronic device. The surface that transmits the haptic output can be a surface of an input device, a cover sheet disposed over a component of the input device, a cover sheet disposed over a component of the electronic device, and/or at least a portion of the enclosure of the electronic device. Haptic output is generated through the production of mechanical movement, vibrations, and/or force. In some embodiments, the haptic output can be created based on an input command (e.g., one or more touch and/or force inputs), a simulation, an application, or a system state. When the haptic output is applied to a surface (or surfaces), a user can detect or feel the haptic output and perceive the haptic output as localized haptic feedback.

The localized haptic output can be produced based on a user interacting with one or more regions of a surface of an electronic device. For example, a user can provide touch and/or force inputs on a cover layer positioned over a display in an electronic device. A user can provide the touch and/or force inputs based on an application or a user interface rendered on the display. In response to at least one touch and/or force input, localized haptic output may be provided to a region of the cover layer.

Additionally or alternatively, localized haptic feedback can be applied to one or more regions of a surface of an electronic device that the user is touching. For example, localized haptic output may be applied to one or more regions of an enclosure of the electronic device when the user is touching the region and/or touching the enclosure.

In a particular embodiment, localized haptic output is provided by an array of piezoelectric haptic actuators. A piezoelectric haptic actuator includes a piezoelectric substrate. The piezoelectric haptic actuator is positioned below a haptic surface of the electronic device (e.g., below a cover sheet) such that a top surface of the piezoelectric substrate is oriented substantially parallel to the haptic surface. A first electrode is affixed to the top surface of the piezoelectric substrate, and a second electrode is affixed to a bottom surface of the piezoelectric substrate opposite the first electrode. The top surface of the piezoelectric substrate is further coupled to a stiffener, which stiffener may impose a mechanical constraint on the movement of the piezoelectric substrate.

Generally, the piezoelectric haptic actuator is actuated by applying a sufficient voltage (e.g., 90 VDC-150 VDC) between the first electrode and the second electrode. This induces a voltage across the piezoelectric substrate, causing the piezoelectric substrate to compress along a plane orthogonal to the induced voltage (hereinafter, the x-y plane). Due to the mechanical constraint imposed on the piezoelectric substrate by the stiffener, the compression along the x-y plane causes the piezoelectric substrate to deflect in a direction orthogonal to the substrate compression (hereinafter, the z-direction). The deflection of the piezoelectric substrate along the z-direction may be transferred through the stiffener and any intervening layers of the electronic device to cause localized deflection at the haptic surface, providing localized haptic output.

As noted above, embodiments of the present invention provide localized haptic output across the haptic surface of the electronic device. Accordingly, an array of piezoelectric haptic actuators is provided below the haptic surface. Localized haptic output may be provided by controllably actuating piezoelectric haptic actuators within the array, either individually or in groups.

In a conventional array of piezoelectric haptic actuators, the piezoelectric haptic actuators may be controlled via a pair of signal control layers, a first layer coupled to the top electrode and a second layer coupled to the bottom electrodes. In a conventional array of piezoelectric haptic actuators, both signal control layers cover substantially the area of the haptic surface. However, given the relatively high voltage levels of the control signals and the large size of each layer, the control signal layers may be costly to manufacture.

Accordingly, embodiments of the present invention relate to low-cost systems and methods for providing control signals to separately controllable piezoelectric haptic actuators. Some embodiments provide a flexible circuit assembly, which includes a master flexible circuit board (hereinafter, master control flex) and a slave flexible circuit board (hereinafter, slave control flex) in a single layer. The master control flex may span substantially a length of the cover sheet between rows of piezoelectric haptic actuators. The slave control flex is coupled to the master control flex, and additionally coupled to a piezoelectric haptic actuator in order to provide control signals to the piezoelectric haptic actuator from the master control flex.

In some embodiments, the electronic device further includes control circuitry to generate control signals for selectively actuating piezoelectric haptic actuators within the array. One or more master control flexes may be coupled to the control circuitry, either directly or through an additional flexible circuit board. The control circuitry may generate a control signal to actuate a given piezoelectric haptic actuator according to an appropriate control scheme (e.g., in response to a detected user touch input). The control signal may be transmitted through the master control flex, through the slave control flex, and to the electrodes disposed on the surface of the piezoelectric substrate of the selected actuator. The control signal may induce a voltage across the piezoelectric substrate, causing the piezoelectric haptic actuator to deflect, which in turn causes a localized deflection at a surface of the electronic device.

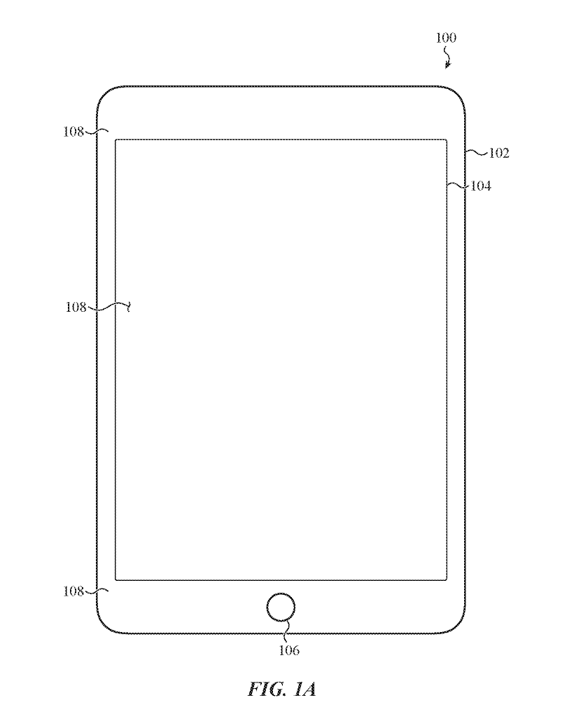

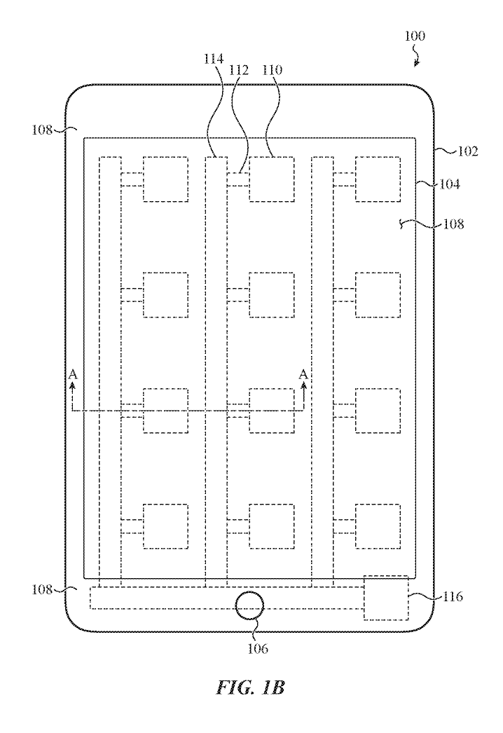

These and other embodiments are discussed below with reference to FIGS. 1-11. However, those skilled in the art will readily appreciate that the detailed description given herein with respect to these Figures is for explanatory purposes only and should not be construed as limiting.

FIGS. 1A-1B depict an example of an electronic device that can provide localized deflection of a surface. In the illustrated embodiment, the electronic device 100 is implemented as a tablet computing device. Other embodiments can implement the electronic device differently. For example, an electronic device can be a smart phone, a laptop computer, a wearable computing device, a digital music player, a kiosk, a stand-alone touch screen display, a mouse, a keyboard, and other types of electronic devices that are configured to provide haptic feedback to a user.

The electronic device 100 includes an enclosure 102 at least partially surrounding a display 104 and one or more input/output (I/O) devices 106. The enclosure 102 can form an outer surface or partial outer surface for the internal components of the electronic device 100. The enclosure 102 can be formed of one or more components operably connected together, such as a front piece and a back piece. Alternatively, the enclosure 102 can be formed of a single piece operably connected to the display 104.

The display 104 can provide a visual output to the user. The display 104 can be implemented with any suitable technology, including, but not limited to, a liquid crystal display (LCD) element, a light emitting diode (LED) element, an organic light-emitting display (OLED) element, an organic electroluminescence (OEL) element, and the like. In some embodiments, the display 104 can function as an input device that allows the user to interact with the electronic device 100. For example, the display can be a multi-touch and/or multi-force sensing touchscreen LED display.

In some embodiments, the I/O device 106 can take the form of a home button, which may be a mechanical button, a soft button (e.g., a button that does not physically move but still accepts inputs), an icon or image on a display, and so on. Further, in some embodiments, the I/O device 106 can be integrated as part of a cover sheet 108 and/or the enclosure 102 of the electronic device. Although not shown in FIG. 1, the electronic device 100 can include other types of I/O devices, such as a microphone, a speaker, a camera, a biometric sensor, and one or more ports, such as a network communication port and/or a power cord port.

A cover sheet 108 may be positioned over the front surface (or a portion of the front surface) of the electronic device 100. At least a portion of the cover sheet 108 can function as an input surface that receives touch and/or force inputs. The cover sheet 108 can be formed with any suitable material, such as glass, plastic, sapphire, or combinations thereof. In one embodiment, the cover sheet 108 covers the display 104 and the I/O device 106. Touch and force inputs can be received by the portion of the cover sheet 108 that covers the display 104 and by the portion of the cover sheet 108 that covers the I/O device 106.

In another embodiment, the cover sheet 108 covers the display 104 but not the I/O device 106. Touch and force inputs can be received by the portion of the cover sheet 108 that covers the display 104. In some embodiments, touch and force inputs can be received on other portions of the cover sheet 108, or on the entire cover sheet 108. The I/O device 106 may be disposed in an opening or aperture formed in the cover sheet 108. In some embodiments, the aperture extends through the enclosure 102 and one or more components of the I/O device 106 are positioned in the enclosure.

As illustrated in FIG. 1B, the electronic device 100 includes an array of haptic actuators 110 below the cover sheet 108 and/or at least a portion of the enclosure 102. The haptic actuators 110 can be configured to provide localized haptic feedback to a user at a surface of the electronic device 100 (e.g., at a surface of the cover sheet 108).

In many embodiments, the haptic actuators 110 may be piezoelectric haptic actuators. The array of haptic actuators 110 may be controllably actuated by application of control signals across opposing surfaces of a piezoelectric substrate. In a conventional device, a first control circuit layer is coupled to a first surface of the piezoelectric substrate, and a second control circuit layer is coupled to a second surface of the piezoelectric substrate. However, such a dual layer control system may be costly, as each circuit layer may extend across an area below the cover sheet.

Accordingly, embodiments of the present invention provide control signals from control circuitry 116 to the array of piezoelectric haptic actuators through a flexible circuit assembly. The flexible circuit assembly includes one or more master flexible circuits (e.g., master control flexes 114) and one or more slave flexible circuits (e.g., slave control flexes 112). A master control flex 114 may be positioned adjacent a row of piezoelectric haptic actuators 110, and may carry control signals to piezoelectric haptic actuators 110 within the row. In many embodiments, a master control flex 114 may be positioned between adjacent rows of piezoelectric haptic actuators 110. The master control flex 114 may further be coupled to the control circuitry 116, either directly or through another flexible circuit.

Each piezoelectric haptic actuator 110 in the array may be coupled to a slave control flex 112. The slave control flex may in turn be coupled to an adjacent master control flex 114 in order to provide control signals from the control circuitry 116, through the master control flex 114, through the slave control flex 114, and to the piezoelectric haptic actuator 110. In this manner, the array of piezoelectric haptic actuators 110 may be selectively controlled to provide localized haptic output to the cover sheet 108 of the electronic device 100.

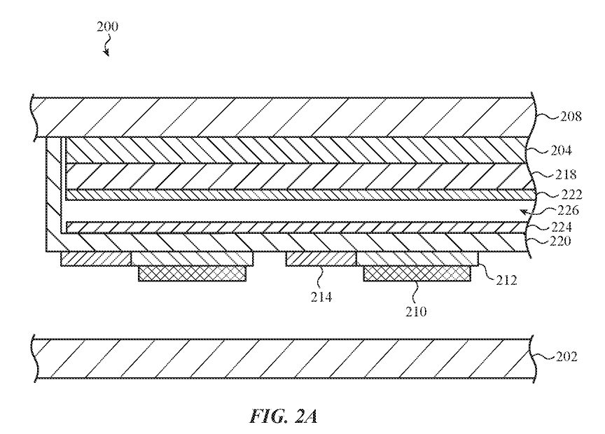

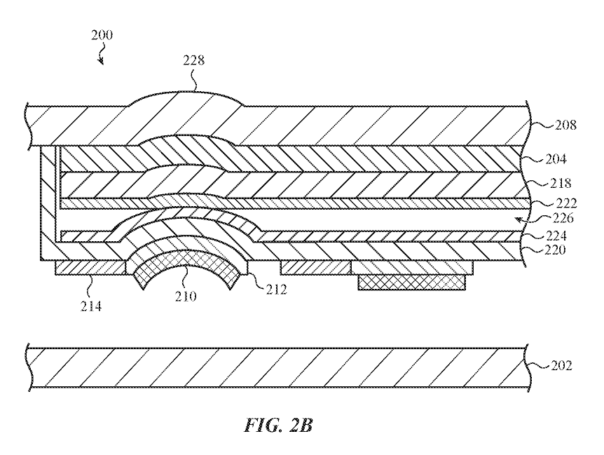

FIGS. 2A and 2B depict cross-sectional views of one example of the electronic device 200 taken along line A-A in FIG. 1B. FIG. 2A depicts the electronic device 200 when the piezoelectric haptic actuators are not actuated, while FIG. 2B depicts the electronic device 200 when a piezoelectric haptic actuator is actuated. In the illustrated embodiments, a display layer 204 is positioned below the cover sheet 208. The display layer 204 includes a display, and may include additional layers such as one or more polarizers, one or more conductive layers, and one or more adhesive layers.

In some embodiments, a backlight unit 218 is positioned below the display layer 204. The display layer 204, along with the backlight unit 218, is used to output images on the display. In some implementations, the backlight unit 218 may be omitted.

The electronic device 200 can also include a support structure 220. In the illustrated embodiment, the support structure 220 is made from a substantially rigid material (e.g., a metal). In other embodiments, the support structure 220 may be formed with a different material (e.g., a plastic) or with a combination of materials (e.g., metal and an elastomer material). In the illustrated embodiments, the support structure 220 may extend around a perimeter of the display layer 204, although this is not required. In this manner, the support structure 220 may form a chassis supporting the layers of the display, including the display layer 204, the backlight unit 218, force sensing components 222, 224, and so on. The support structure 220 can have any shape and/or dimensions in other embodiments.

In some embodiments, the support structure 220 can be attached to the cover sheet 208 such that the support structure 220 is suspended from the cover sheet 208. In other embodiments, the support structure 220 may be connected to a component other than the cover sheet 208. For example, the support structure 220 can be attached to the enclosure 202 of the electronic device 200, or to a frame or other support component in the electronic device 200. For example, the support structure 220 can be attached to a support component positioned below the support structure 220. In such embodiments, the support structure 220 can include one or more legs that contact the support component and position the support structure 220 at a given location within the electronic device 200 (e.g., below the display layer 204 or below the backlight unit 218 when the backlight unit 218 is present).

An array of piezoelectric haptic actuators 210 may be affixed or coupled, through a circuit layer (e.g., a slave flexible circuit or slave control flex 212), to a surface of the support structure 220. Although the array is depicted with two piezoelectric haptic actuators 210, other embodiments are not limited to this configuration. The array can include one or more piezoelectric haptic actuators 210. Further, in some embodiments the support structure 220 may be omitted, and the piezoelectric haptic actuators 210 may be coupled to another layer below the cover sheet 208, such as the backlight unit 218.

In the illustrated embodiment, each piezoelectric haptic actuator 210 is attached and electrically connected to a slave control flex 212. Any suitable circuit configuration can be used for the slave control flex 212. For example, in one embodiment the slave control flex 212 may be a flexible printed circuit board. The slave control flex 212 includes signal lines that are electrically connected to a corresponding piezoelectric haptic actuator 210.

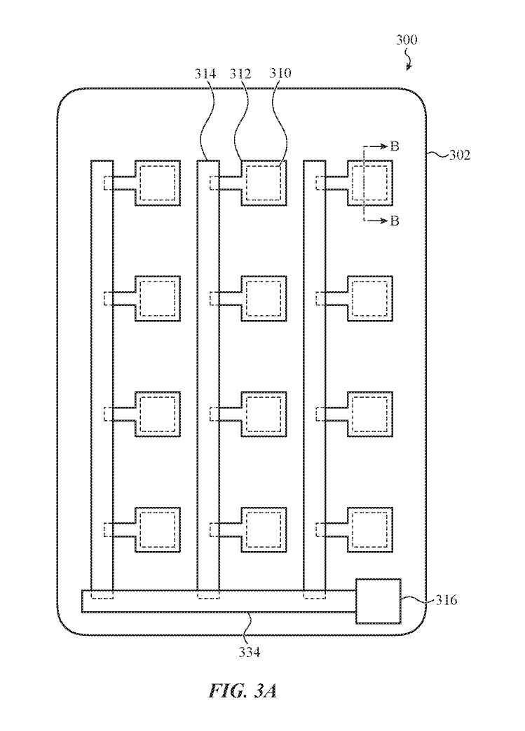

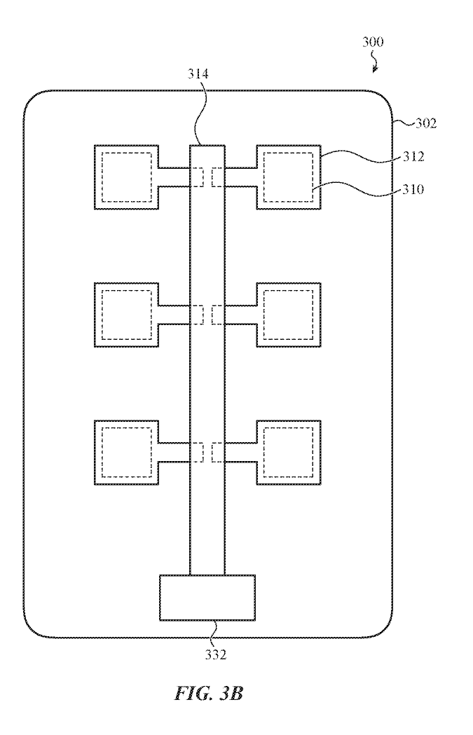

Each slave control flex 212 is further electrically connected to an additional circuit (e.g., a master flexible circuit or master control flex 214). In many embodiments, a master control flex 214 may span along a row of piezoelectric haptic actuators 210 (as further illustrated below with respect to FIGS. 3A-3B), coupling the signal lines in each piezoelectric haptic actuator 210 in the row to control circuitry. The signal lines can be used to transmit electrical signals to each piezoelectric haptic actuator 210 to selectively actuate one or more piezoelectric haptic actuators 210. When two or more piezoelectric haptic actuators 210 are activated, the piezoelectric haptic actuators 210 can be actuated concurrently, sequentially, or overlapping in time.

The master control flex 214 can be electrically connected to control circuitry (for example, control circuitry 316 as depicted in FIGS. 3A-3B). In some embodiments, the master control flex 214 is directly connected to the control circuitry. In other embodiments, each master control flex 214 may be coupled to another flexible circuit, which connects multiple master control flexes 214 to the control circuitry. The control circuitry may generate control signals for selectively actuating the one or more of the array of piezoelectric haptic actuators 210. The control signals may be carried along conducting paths (e.g., traces or wires) within the master control flex 214 to each slave flex 212, and on to electrodes on the piezoelectric haptic actuators 210.

Accordingly, the master control flex 214 and slave control flex 212 are each formed with a flexible substrate. The flexible substrate may be formed from an appropriate material, such as, but not limited to: polyethylene terephthalate, polyimide, polyethylene naphthalate, polyetherimide, fluropolymer, copolymer, plastic, ceramic, glass, or any combination thereof. The master control flex 314 further includes conductive paths (e.g., traces or wires) disposed on or within the flexible substrate, which conductive paths may include materials such as, but not limited to: copper, silver, gold, constantan, karma, isoelastic, indium tin oxide, or any combination thereof. The conductive paths may be formed or deposited using a suitable disposition technique such as, but not limited to: vapor deposition, sputtering, printing, roll-to-roll processing, gravure, pick and place, adhesive, mask-and-etch, and so on.

In the illustrated embodiment, the array of piezoelectric haptic actuators 210 is coupled to a bottom surface of the support structure 220. However, in other implementations, one or more piezoelectric haptic actuators 210 may be coupled to a top surface and/or a side of the support structure 220. In yet other implementations, one or more piezoelectric haptic actuators 210 may be coupled to the top surface and/or the bottom surface of the support structure 220.

In many embodiments, each piezoelectric haptic actuator 210 is a piezoelectric transducer. The piezoelectric transducer may be formed from an appropriate piezoelectric material, such as sodium potassium niobate, lead zirconate titanate (PZT), quartz, and other ceramic or non-ceramic materials. A piezoelectric transducer is actuated with an electrical signal. When activated, the piezoelectric transducer converts the electrical signal into mechanical movement, vibrations, and/or force(s). The mechanical movement, vibrations, and/or force(s) generated by the actuated haptic actuator(s) is known as haptic output. When the haptic output is applied to a surface, a user can detect or feel the haptic output and perceive the haptic output as haptic feedback.

Each piezoelectric haptic actuator 210 can be selectively activated in the embodiment shown in FIGS. 2A-2B. In particular, as previously noted, each individual piezoelectric haptic actuator 210 can receive an electrical signal via the master control flex 214 and slave control flex 212 independent of the other piezoelectric haptic actuators 210. The haptic output produced by one or more piezoelectric haptic actuators 210 can cause the support structure 220 to deflect or otherwise move. The deflection(s) of the support structure 220 can transmit through the backlight unit 218 and through the display layer 204 to the cover sheet 208. The transmitted deflection(s) cause one or more sections of the cover sheet 208 to deflect or move to provide localized haptic feedback to the user. In particular, the cover sheet 208 bends or deflects at a location that substantially corresponds to the location of the activated piezoelectric haptic actuator(s) 210 on the support structure 220.

The layer or layers between the cover sheet 208 and the support structure 220 are referred to herein as intermediate layer(s). In the illustrated embodiment, the display layer 204 and the backlight unit 218 are intermediate layers. The support structure 220 is constructed and attached to the cover sheet 208 to define a gap 226 between the support structure 220 and an intermediate layer (e.g., the backlight unit 218). In some embodiments, a first force-sensing component 222 and a second force-sensing component 224 may be positioned within the gap 226. For example, the first force-sensing component 222 can be affixed to the bottom surface of the backlight unit 218 and the second force-sensing component 224 to the top surface of the support structure 220. Thus, in the illustrated embodiment, the first and second force-sensing components 222, 224 are also intermediate layers.

Together, the first and second force-sensing components 222, 224 form a force-sensing device. The force-sensing device can be used to detect an amount of force that is applied to the cover sheet 208. In some implementations, the first force-sensing component 222 represents a first array of electrodes and the second force-sensing component 224 a second array of electrodes. The first and second arrays of electrodes can each include one or more electrodes. Each electrode in the first array of electrodes is aligned in at least one direction (e.g., vertically) with a respective electrode in the second array of electrodes to form an array of capacitive sensors. The capacitive sensors are used to detect a force applied to the cover sheet 208 through measured capacitances or measured changes in capacitances. For example, as the cover sheet 208 deflects in response to an applied amount of force, a distance between the electrodes in at least one capacitive sensor changes, which varies the capacitance of that capacitive sensor. Drive and sense circuitry can be operatively (e.g., electrically) connected to each capacitive sensor and configured to sense or measure the capacitance of each capacitive sensor. A processing unit may be operatively (e.g., electrically) connected to the drive and sense circuitry and configured to receive signals representing the measured capacitance of each capacitive sensor. The processing unit can be configured to correlate the measured capacitances into an amount or magnitude of force.

In other embodiments, the first and second force-sensing components 222, 224 can employ a different type of sensor to detect force or the deflection of the first force-sensing component 222 relative to the second force-sensing component 224. In some representative examples, the first and second force-sensing components 222, 224 can each represent an array of optical displacement sensors, magnetic displacement sensors, or inductive displacement sensors.

In other embodiments, the first-force sensing component 222 and/or the second force-sensing component 224 can be positioned at a different location within the electronic device 200. For example, the first force-sensing component 222 may be positioned between the display layer 204 and the backlight unit 218. Additionally or alternatively, one of the force-sensing components 222, 224 can be omitted. For example, in some embodiments, the first force-sensing component 222 may be omitted. The second force-sensing component 224 can detect the amount or magnitude of an applied force based on an amount of displacement between the backlight unit 218 or the display layer 204.

In some embodiments, one or both force-sensing components 222, 224 can be used to detect one or more touches on the cover sheet 208. In such embodiments, the force-sensing component(s) has a dual function in that it is used to detect both touch and force inputs. Other embodiments can include a separate touch-sensing device in the electronic device. As one example, a touch-sensing device may be positioned between the cover sheet 208 and the display layer 204.

In some embodiments, the array of piezoelectric haptic actuators 210, the first force-sensing component 222, and/or the second force-sensing component 224 may work together to enhance a user's experience. In one non-limiting example, at least one piezoelectric haptic actuator 210 may provide haptic or tactile output in response to a force input (e.g., a force applied to the cover sheet 208). Alternatively, at least one piezoelectric haptic actuator 210 can provide haptic or tactile output in response to a force input having an amount of force that exceeds a given threshold. Additionally or alternatively, in some implementations, at least one piezoelectric haptic actuator 210 may provide a first type of haptic output or a haptic output at a first location in response to a first amount of detected force, and may provide a second type of haptic output or a haptic output at a second location in response to a second amount of detected force.

In addition to the above, the array of piezoelectric haptic actuators 210, the first force-sensing component 222, and/or the second force-sensing component 224 may also work in conjunction to determine a location of a received touch input and/or force input. When such a location is determined, actuation of at least one piezoelectric haptic actuator 210 and any associated haptic output may be localized at the determined position.

In another implementation, at least one piezoelectric haptic actuator 210 may provide haptic output in an area surrounding or adjacent the determined location. To achieve this, one or more piezoelectric haptic actuators 210, or portions of the array of piezoelectric haptic actuators 210, may be actuated at different times and at different locations to effectively cancel out (or alternatively enhance) the haptic output.

FIG. 2B shows a cross-sectional view of the electronic device shown in FIG. 2A when a piezoelectric haptic actuator 210 is actuated and produces a localized deflection in the cover sheet 208. In the illustrated embodiment, the piezoelectric haptic actuator 210 in the array has been activated with an electrical signal. The piezoelectric haptic actuator 210 moves (e.g., contracts) in response to the electrical signal, which causes the support structure 220 to deflect. While being deflected, the support structure 220, the slave control flex 212, and the second force-sensing component 224 move into the gap 226 and contact the first force-sensing component 222. The deflection of the support structure 220 propagates through the first force-sensing component 222, the backlight unit 218, the display layer 204, and the cover sheet 208. In response to the transmitted deflection, the cover sheet 208 bends or deflects at a location 228 that substantially corresponds to the location of the piezoelectric haptic actuator 210 on the support structure 220. The cover sheet 208 around the deflected location 228 is substantially unaffected by the haptic output produced by the piezoelectric haptic actuator 210. A user can detect the local deflection of the cover sheet 208 and perceive the deflection as localized haptic feedback.

In the embodiments shown in FIGS. 2A and 2B, the array of piezoelectric haptic actuators 210, the slave control flex 212, and the support structure 220 collectively form a haptic or deflection module.

FIGS. 3A-3B depict examples of the control circuit layer or flexible circuit assembly (including master control flex 314 and slave control flex 312) over an array of piezoelectric haptic actuators 310. FIG. 3A depicts a plan view of an example control circuit layer of the electronic device 300. Although the array of piezoelectric haptic actuators 310 is shown as having twelve piezoelectric haptic actuators 310, other embodiments are not limited to this configuration. The array of piezoelectric haptic actuators 310 can include one or more piezoelectric haptic actuators 310 in still other embodiments. Each piezoelectric haptic actuator 310 is depicted in a square shape. In some embodiments the piezoelectric haptic actuators 310 may have any given shape, such as a round, rectangular, triangular, or other geometric shape (including non-regular geometric shapes).

The piezoelectric haptic actuators 310 are attached and electrically connected to the circuit layer. Each of the piezoelectric haptic actuators 310 is attached and electrically connected to a slave flexible circuit (e.g., a slave control flex 312). Each slave control flex 312 is, in turn, attached and electrically connected to an adjacent master flexible circuit (e.g., a master control flex 314). The master control flex 314 and slave control flex 312 are configured to provide electrical signals to each individual piezoelectric haptic actuator 310 to selectively actuate one or more piezoelectric haptic actuators 310 concurrently, with some overlap in time, or sequentially.

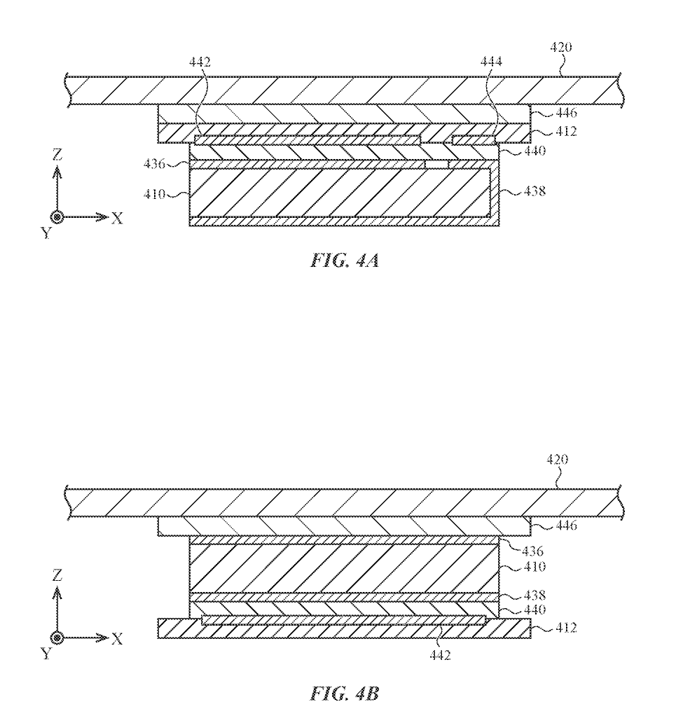

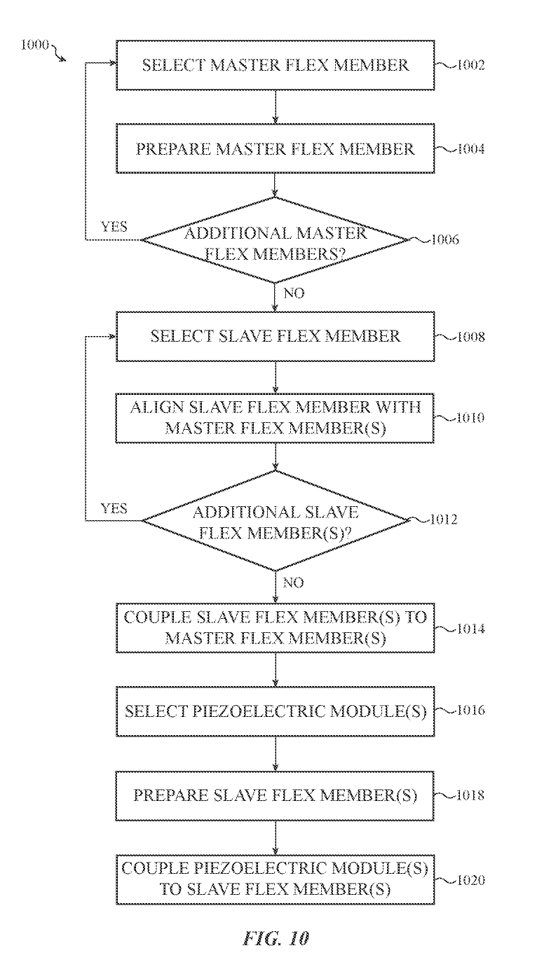

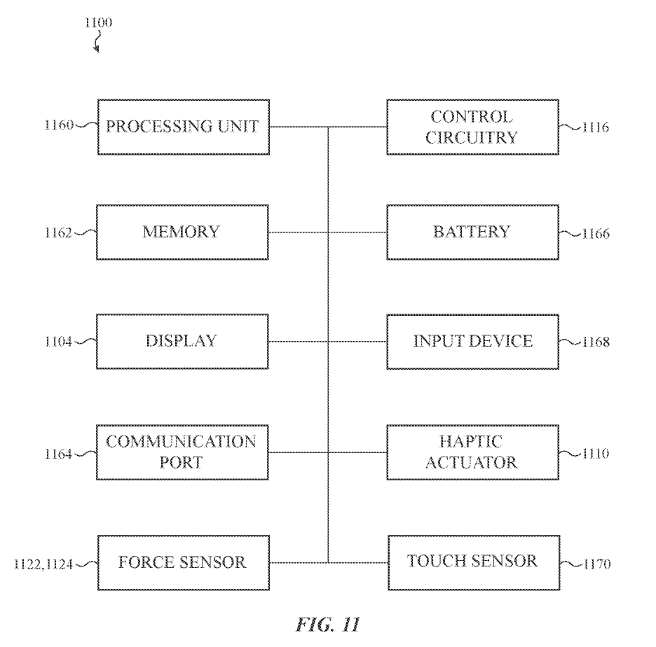

Any suitable attachment method can be used to affix each piezoelectric haptic actuator 310 to a corresponding slave control flex 312. For example, in one embodiment an isotropic conductive film or anisotropic conductive film is used to attach a piezoelectric haptic actuator 310 to a slave control flex 312 (see FIGS. 4A-4B). Additionally, any suitable method can be used to attach the master control flex 314 to the slave control flex 312. For example, the master control flex 314 may be attached to the slave control flex 312 by soldering, ultrasonic welding, laser welding, isotropic conductive film, anisotropic conductive film, and so on (see FIG. 10).

The master control flex 314 may be operatively (e.g., electrically) connected to control circuitry 316 through an additional flexible circuit 334. In some embodiments, the additional flexible circuit 334 may be a separate circuit coupled to each master control flex 314 by an appropriate method (e.g., a conductive film). In other embodiments, the additional flexible circuit 334 and one or more master control flexes 314 are formed as a single component. The additional flexible circuit 334 transmits electrical signals from the control circuitry 316 to respective conductors or traces in the master control flex 314. The signal lines or electrical traces in the master control flex 314 transmit one or more electrical signals to at least one slave control flex 312, which may actuate a corresponding piezoelectric haptic actuator 310.

In some embodiments, the master control flex 314 and slave control flex 312 carry both a control signal and a reference voltage (e.g., a ground reference) to each piezoelectric haptic actuator 310. In other embodiments, a support structure (such as the support structure 220 in FIGS. 2A-2B) may carry the reference voltage while the master control flex 314 and slave control flex 312 carry a control signal to each piezoelectric haptic actuator 310.

The control circuitry 316 is configured to control the generation of electrical control signals for the array of piezoelectric haptic actuators 310. The control circuitry 316 can be implemented as any electronic device capable of processing, receiving, or transmitting data or instructions. For example, the control circuitry 316 can be a microprocessor, a central processing unit (CPU), an application-specific integrated circuit (ASIC), a digital signal processor (DSP), or combinations of multiple such devices. As described herein, the term “control circuitry” is meant to encompass a single processor or processing unit, multiple processors, multiple processing units, or other suitably configured computing element or elements.

In some embodiments, a memory (such as memory 1162 depicted in FIG. 11) can be operatively (e.g., electrically) connected to the control circuitry 316. The memory can be configured as any type of memory. By way of example only, memory can be implemented as random access memory, read-only memory, Flash memory, removable memory, or other types of storage elements, in any combination.

The memory can store electronic data that can be used by the control circuitry 316. For example, the memory can store electrical data or content, such as timing signals, algorithms, and one or more different electrical signal characteristics that the control circuitry 316 can use to produce one or more electrical signals. The electrical signal characteristics include, but are not limited to, an amplitude, a phase, a frequency, and/or a timing of an electrical signal. The control circuitry 316 can cause the one or more electrical signal characteristics to be transmitted through the master control flexes 314 and slave control flexes 312 to one or more of the array of piezoelectric haptic actuators 310.

In some embodiments, each piezoelectric haptic actuator 310 can produce different types of haptic output based on the signal characteristic(s) of the electrical signal that is used to actuate the piezoelectric haptic actuator 310. For example, a piezoelectric haptic actuator 310 can generate haptic output that varies in magnitude and/or frequency based on the particular signal characteristics of the electrical signal used to activate the piezoelectric haptic actuator 310.

FIG. 3B depicts a plan view of another example control circuit layer of the electronic device 300. Although the array of piezoelectric haptic actuators 310 is shown as having six piezoelectric haptic actuators 310, other embodiments are not limited to this configuration. The example depicted in FIG. 3B includes a single master control flex 312, with multiple slave control flexes 310 branching in multiple directions. It should be understood that in other embodiments different numbers and arrangements of master control flex 314 may be implemented.

The piezoelectric haptic actuators 310 are attached and electrically connected to the circuit layer. Each of the piezoelectric haptic actuators 310 is attached and electrically connected to a slave flexible circuit (e.g., a slave control flex 312). Each slave control flex 312 is, in turn, attached and electrically connected to the central master flexible circuit (e.g., a master control flex 314). The master control flex 314 and slave control flex 312 are configured to provide electrical signals to each individual piezoelectric haptic actuator 310 to selectively actuate one or more piezoelectric haptic actuators 310 concurrently, with some overlap in time, or sequentially.

Any suitable attachment method can be used to affix each piezoelectric haptic actuator 310 to a corresponding slave control flex 312 and each slave control flex 312 to the central master control flex 314, such as discussed above with respect to FIG. 3A. The master control flex 314 may be operatively (e.g., electrically) connected to control circuitry 316. Similar to the example depicted in FIG. 3A, in some embodiments the master control flex 314 and slave control flex 312 carry both a control signal and a reference voltage (e.g., a ground reference) to each piezoelectric haptic actuator 310. In other embodiments, a support structure (such as the support structure 220 in FIGS. 2A-2B) may carry the reference voltage while the master control flex 314 and slave control flex 312 carry a control signal to each piezoelectric haptic actuator 310.

The control circuitry 316 is configured to control the generation of electrical control signals for the array of piezoelectric haptic actuators 310. The control circuitry 316 can be implemented as any electronic device capable of processing, receiving, or transmitting data or instructions, such as discussed above with respect to FIG. 3A. In some embodiments, a memory (such as memory 1162 depicted in FIG. 11) can be operatively (e.g., electrically) connected to the control circuitry 316. The memory can store electronic data that can be used by the control circuitry 316.

FIGS. 4A-4B depict cross-sectional views of example haptic actuator modules of the electronic device taken along line B-B in FIG. 3A. FIG. 4A depicts an example haptic actuator module in which the slave control flex 412 carries both a reference and control signal. The haptic actuator module includes a piezoelectric substrate 410. The piezoelectric substrate 410 may be formed from a suitable material, such as a ceramic piezoelectric material. Example materials include potassium-based ceramics (e.g., potassium-sodium niobate. potassium niobate), lead-based ceramics (e.g., PZT, lead titanate), quartz, bismuth ferrite, and other suitable piezoelectric materials. When a voltage is applied across the piezoelectric substrate 410, the voltage may induce the piezoelectric substrate 410 to expand or contract in a direction or plane orthogonal to the applied voltage (i.e., the x-y plane).

A voltage may be applied across the piezoelectric substrate 410 via electrodes 436, 438 formed on opposing surfaces of the piezoelectric substrate 410. A first electrode 436 (e.g., a top electrode) is formed on a top surface of the piezoelectric substrate 410, while a second electrode 438 (e.g., a bottom electrode) is formed on a bottom surface of the piezoelectric substrate 410. In many embodiments, the second electrode 438 wraps around the piezoelectric substrate 410 such that a portion of the second electrode is disposed on the top surface of the piezoelectric substrate 410. In this manner, a reference voltage and control voltage may be provided at a same interface (e.g., between the top surface of the piezoelectric substrate 410 and a slave control flex 412).

The electrodes 436, 438 may be formed from a suitable conductive material, such as metal (e.g., silver, nickel, copper, aluminum, gold), polyethyleneioxythiophene (PEDOT), indium tin oxide (ITO), graphene, piezoresistive semiconductor materials, piezoresistive metal materials, and the like. The first electrode 436 may be formed from the same material as the second electrode 438, while in other embodiments the electrodes 436, 438 may be formed from different materials. The electrodes 436, 438 may be formed or deposited using a suitable disposition technique such as, but not limited to: vapor deposition, sputtering, plating, printing, roll-to-roll processing, gravure, pick and place, adhesive, mask-and-etch, and so on. A mask or similar technique may be applied to form a patterned top surface of the piezoelectric substrate 410 and/or a wraparound second electrode 438.

The top surface of the piezoelectric substrate is coupled to a support structure 420 via a slave control flex 412. The support structure 420 may be substantially similar to the support structure 220 depicted in FIGS. 2A-2B. The support structure imposes a mechanical constraint on the movement of the piezoelectric substrate 410 in the x-y plane. When a sufficient voltage (e.g., 90 VDC-150 VDC) is applied between the first electrode 436 and the second electrode 438, a voltage is induced in the piezoelectric substrate 410. The induced voltage causes the piezoelectric substrate 410 to compress along the plane orthogonal to the induced voltage (i.e., the x-y plane).

Due to the mechanical constraint imposed by the support structure 420, the piezoelectric substrate 410 instead deflects along the z-direction (see FIGS. 2A-2B). In some embodiments, the support structure 420 may be omitted, and the cover sheet and intermediate layers of the device may impose a similar mechanical constraint on the movement of the piezoelectric substrate 410. For example, each layer between the cover sheet and the piezoelectric substrate 410 depicted in FIGS. 2A-2B may be sufficiently bonded to the next layer to impose a mechanical constraint on the movement of the piezoelectric substrate 410 when actuated.

Returning to FIG. 4A, the piezoelectric substrate 410 may be coupled to a slave control flex 412. The slave control flex 412 includes a first conductor 442 configured to conduct an electrical control signal to the first electrode 436. The slave control flex 412 also includes a second conductor 444 configured to conduct a reference voltage level to the second electrode 438. In other embodiments the roles of the first conductor 442 and second conductor 444 may be reversed.

The piezoelectric substrate 410 may be coupled to the slave control flex 412 by an adhesive layer 440, which may be an anisotropic conductive film. The anisotropic conductive film of the adhesive layer 440 may facilitate conduction from the first conductor 442 in the slave control flex 412 to the first electrode 436 on the piezoelectric substrate 410 and from the second conductor 444 to the second electrode 438. The anisotropic conductive film may further isolate these conduction paths to prevent an undesired short between the conductors 442, 444 or electrodes 436, 438.

In this manner, the piezoelectric substrate 410 may be coupled and electrically connected to the slave control flex 412, providing conduction paths from control circuitry to the top surface and bottom surface of the piezoelectric substrate. In other embodiments, the piezoelectric substrate 410 may be coupled and electrically connected to the slave control flex 412 by isolated segments of isotropic conductive film, an anisotropic or isotropic conductive paste, or another appropriate method.

The slave control flex 412 is further coupled to the support structure 420 through an additional adhesive layer 446. The additional adhesive layer 446 may be any adhesive or bonding agent suitable for promoting adhesion between the slave control flex 412 and the support structure 420. In some embodiments, the additional adhesive layer 446 may be formed from a pressure-sensitive adhesive.

FIG. 4B depicts another example haptic actuator module in which the slave control flex 412 carries a control signal and the support structure 420 carries a reference voltage level. The haptic actuator module includes a piezoelectric substrate 410. The piezoelectric substrate 410 may be formed from a suitable material, such as a ceramic piezoelectric material. Example materials include potassium-based ceramics (e.g., potassium-sodium niobate. potassium niobate), lead-based ceramics (e.g., PZT, lead titanate), quartz, bismuth ferrite, and other suitable piezoelectric materials.

As with the example embodiment of FIG. 4A, when a voltage is applied across the piezoelectric substrate 410, the voltage may induce the piezoelectric substrate 410 to expand or contract in a direction or plane orthogonal to the applied voltage (i.e., the x-y plane). The piezoelectric substrate 410 may be coupled to the support structure 420, which imposes a mechanical constraint on the movement of the piezoelectric substrate 410. Accordingly, when a voltage is induced across the piezoelectric substrate 410, the piezoelectric substrate 410 may contract along the x-y plane, causing a deflection in the z-direction due to the constraint imposed by the support structure 420.

A voltage may be applied across the piezoelectric substrate 410 via electrodes 436, 438 formed on opposing surfaces of the piezoelectric substrate 410. A first electrode 436 (e.g., a top electrode) is formed on a top surface of the piezoelectric substrate 410, while a second electrode 438 (e.g., a bottom electrode) is formed on a bottom surface of the piezoelectric substrate 410.

The electrodes 436, 438 may be formed from a suitable conductive material, such as metal (e.g., silver, nickel, copper, aluminum, gold), polyethyleneioxythiophene (PEDOT), indium tin oxide (ITO), graphene, piezoresistive semiconductor materials, piezoresistive metal materials, and the like. The first electrode 436 may be formed from the same material as the second electrode 438, while in other embodiments the electrodes 436, 438 may be formed from different materials. The electrodes 436, 438 may be formed or deposited using a suitable disposition technique such as, but not limited to: vapor deposition, sputtering, plating, printing, roll-to-roll processing, gravure, pick and place, adhesive, mask-and-etch, and so on.

The top surface of the piezoelectric substrate 410 is coupled to a support structure 420 by an adhesive layer 446. The support structure 420 may be substantially similar to the support structure 220 depicted in FIGS. 2A-2B. The support structure 420 may be biased with a reference voltage in order to provide a common reference voltage to the first electrode 436 on each of an array of piezoelectric substrates 410. The adhesive layer 446 may be an isotropic conductive film, which may facilitate conduction from the support structure 420 to the first electrode 436 on the piezoelectric substrate 410.

The piezoelectric substrate 410 is further coupled to a slave control flex 412. The slave control flex 412 includes a conductor 442 configured to conduct an electrical control signal to the second electrode 438. The piezoelectric substrate 410 may be coupled to the slave control flex 412 by an additional adhesive layer 440, which may be an isotropic conductive film. The isotropic conductive film of the additional adhesive layer 440 may facilitate conduction from the conductor 442 in the slave control flex 412 to the second electrode 438 on the piezoelectric substrate 410.

In this manner, the piezoelectric substrate 410 may be coupled and electrically connected to the support structure 420 and the slave control flex 412, providing conduction paths from control circuitry to the top surface and bottom surface of the piezoelectric substrate 410. In other embodiments, the piezoelectric substrate 410 may be coupled and electrically connected to the support structure 420 and the slave control flex 412 by anisotropic conductive film, anisotropic or isotropic conductive paste, or another appropriate method.

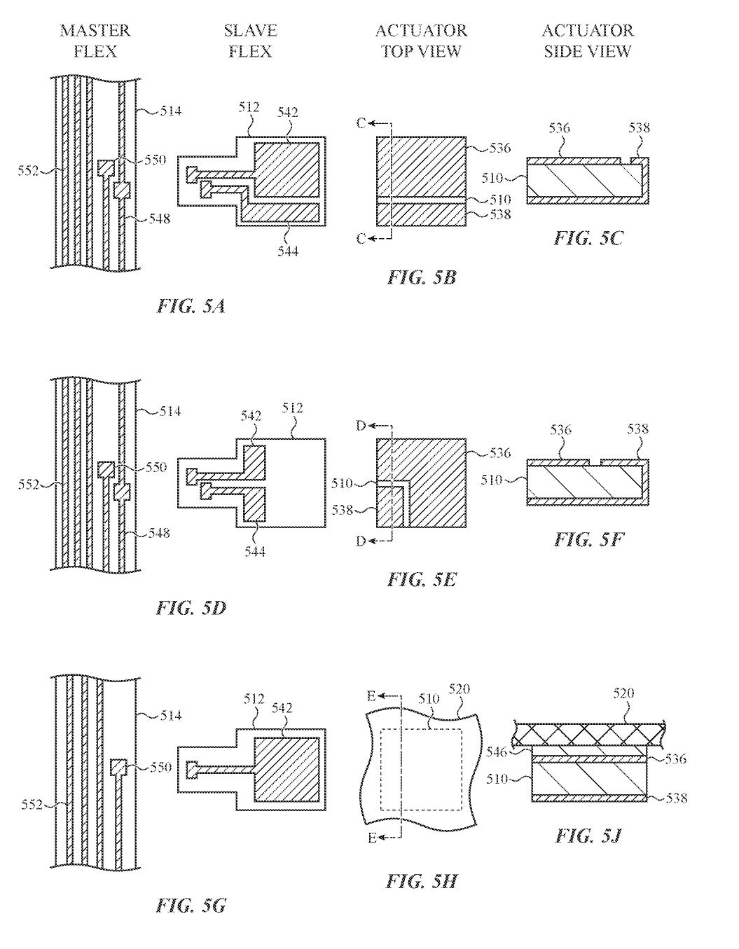

FIGS. 5A-5J depict example configurations of a master control flex, slave control flex, and piezoelectric haptic actuator. The examples depicted in FIGS. 5A-5J are intended to be illustrative, and it should be understood that variations in size, shape, and other parameters are included in the scope of the present invention.

FIGS. 5A-5C depict a first example master control flex, slave control flex, and piezoelectric haptic actuator, which may correspond to the example haptic actuator module depicted in FIG. 4A. FIG. 5A depicts an example master control flex 514, configured to couple to a slave control flex 512. The master control flex 514 includes a reference voltage conductor 548 and a control signal conductor 550. In some embodiments, the master control flex 514 includes additional control signal conductors 552 (e.g., for controlling additional piezoelectric haptic actuators 510), though this is not required.

The slave control flex 512 includes a first conductor 542, which is configured to provide a control signal from the control signal conductor 550 in the master control flex 514 to a first electrode 536 on the top surface of a piezoelectric haptic actuator, such as the piezoelectric haptic actuator 510 depicted in FIGS. 5B and 5C. The slave control flex 512 further includes a second conductor 544, which is configured to provide a reference voltage level from the reference voltage conductor 548 in the master control flex 514 to a second electrode 538 on the bottom surface of the piezoelectric haptic actuator 510. The second conductor 544 may couple to a wrap-around portion of the second electrode 538, as depicted in FIG. 4A.

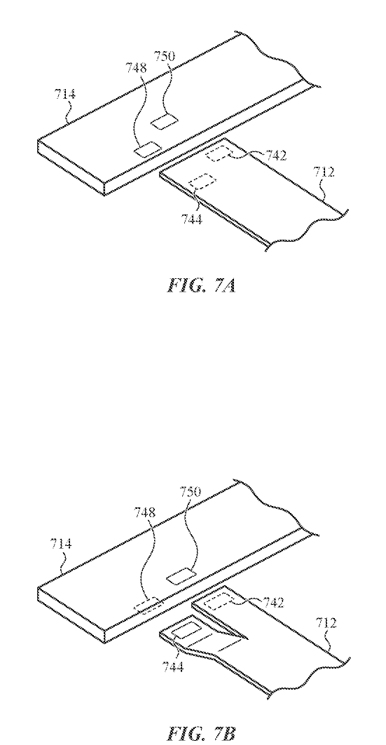

The slave control flex 512 and master control flex 514 may be formed substantially as described with respect to FIG. 3A. The slave control flex 512 may be coupled and electrically connected to the master control flex 514 by an appropriate method, such as by an anisotropic or isotropic conductive film (see FIGS. 7A-7B).

FIG. 5B depicts a top view of an example piezoelectric haptic actuator 510, having a first electrode 536 disposed along a majority of the top surface and a wraparound portion of a second electrode 538 disposed along a thin portion of a width of the top surface. FIG. 5C depicts a cross-section view of the example piezoelectric haptic actuator, taken along line C-C of FIG. 5B. The first electrode 536 may correspond to the first conductor 542 in the slave control flex 512, and the second electrode may correspond to the second conductor in the slave control flex 512 depicted in FIG. 5A. The piezoelectric haptic actuator 510 depicted in FIGS. 5B and 5C may be coupled to the slave control flex 512 depicted in FIG. 5A by an appropriate method, such as described with respect to FIGS. 4A and 10.

FIGS. 5D-5F depict a second example master control flex, slave control flex, and piezoelectric haptic actuator, which may correspond to the example haptic actuator module depicted in FIG. 4A. FIG. 5D depicts an example master control flex 514, configured to couple to a slave control flex 512. The master control flex 514 includes a reference voltage conductor 548 and a control signal conductor 550. In some embodiments, the master control flex 514 includes additional control signal conductors 552 (e.g., for controlling additional piezoelectric haptic actuators 510), though this is not required.

The slave control flex 512 includes a first conductor 542, which is configured to provide a control signal from the control signal conductor 550 in the master control flex 514 to a first electrode 536 on the top surface of a piezoelectric haptic actuator, such as the piezoelectric haptic actuator 510 depicted in FIGS. 5E and 5F. The slave control flex 512 further includes a second conductor 544, which is configured to provide a reference voltage level from the reference voltage conductor 548 in the master control flex 514 to a second electrode 538 on the bottom surface of the piezoelectric haptic actuator 510. The second conductor 544 may couple to a wrap-around portion of the second electrode 538, as depicted in FIG. 4A.

The first conductor 542 and second conductor 544 depicted in FIG. 5D have a smaller area for coupling to the piezoelectric haptic actuator 510 than the first embodiment depicted in FIG. 5A. The smaller area of the conductors 542, 544 in the slave control flex 512 may further reduce the manufacturing cost of the slave control flex 512. Additionally, the smaller area of the conductors 542, 544 may allow for a smaller wrap-around portion of the second electrode 538 on the piezoelectric haptic actuator 510. This may increase the surface area of the first electrode 536 (see FIG. 5E), which may in turn improve the haptic response of the piezoelectric haptic actuator 510 to an applied control signal.

The slave control flex 512 and master control flex 514 may be formed substantially as described with respect to FIG. 3A. The slave control flex 512 may be coupled and electrically connected to the master control flex 514 by an appropriate method, such as by an anisotropic or isotropic conductive film (see FIGS. 7A-7B).

FIG. 5E depicts a top view of an example piezoelectric haptic actuator 510, having a first electrode 536 disposed along a majority of the top surface and a wraparound portion of a second electrode 538 disposed along a thin portion of a width of the top surface. FIG. 5F depicts a cross-section view of the example piezoelectric haptic actuator, taken along line D-D of FIG. 5E. The first electrode 536 may correspond to the first conductor 542 in the slave control flex 512, and the second electrode may correspond to the second conductor in the slave control flex 512 depicted in FIG. 5D. The piezoelectric haptic actuator 510 depicted in FIGS. 5E and 5F may be coupled to the slave control flex 512 depicted in FIG. 5D by an appropriate method, such as described with respect to FIGS. 4A and 10.

FIGS. 5G-5J depict a third example master control flex, slave control flex, and piezoelectric haptic actuator, which may correspond to the example haptic actuator module depicted in FIG. 4B. FIG. 5G depicts an example master control flex 514, configured to couple to a slave control flex 512. The master control flex 514 includes a control signal conductor 550. In some embodiments, the master control flex 514 includes additional control signal conductors 552 (e.g., for controlling additional piezoelectric haptic actuators 510), though this is not required.

In the examples depicted in FIGS. 5G-5J, the piezoelectric haptic actuator 510 is coupled to a support structure 520, which is biased with a reference voltage level. Accordingly, the support structure 520 is at least partially formed from a conductive material, and is coupled and electrically connected to a first electrode 536 on a top surface of the piezoelectric haptic actuator 510 depicted in FIGS. 5H and 5J.

The slave control flex 512 includes a conductor 542, which is configured to provide a control signal from the control signal conductor 550 in the master control flex 514 to a second electrode 538 on the bottom surface of the piezoelectric haptic actuator 510. The slave control flex 512 and master control flex 514 may be formed substantially as described with respect to FIG. 3A. The slave control flex 512 may be coupled and electrically connected to the master control flex 514 by an appropriate method, such as by an anisotropic or isotropic conductive film (see FIGS. 7A-7B).

FIG. 5H depicts a top view of an example piezoelectric haptic actuator 510, coupled to a conductive support structure 520. FIG. 5J depicts a cross-section view of the example piezoelectric haptic actuator, taken along line E-E of FIG. 5H. As depicted, the first electrode 536 is disposed across a substantial majority or the entirety of the top surface of the piezoelectric haptic actuator 510, while the second electrode 538 is similarly disposed across a substantial majority or the entirety of the bottom surface of the piezoelectric haptic actuator 510. The slave control flex may further correspond to the conductor 542 in the slave control flex 512. The bottom of the piezoelectric haptic actuator 510 depicted in FIGS. 5H and 5J may be coupled to the slave control flex 512 depicted in FIG. 5G by an appropriate method, such as described with respect to FIGS. 4B and 10.

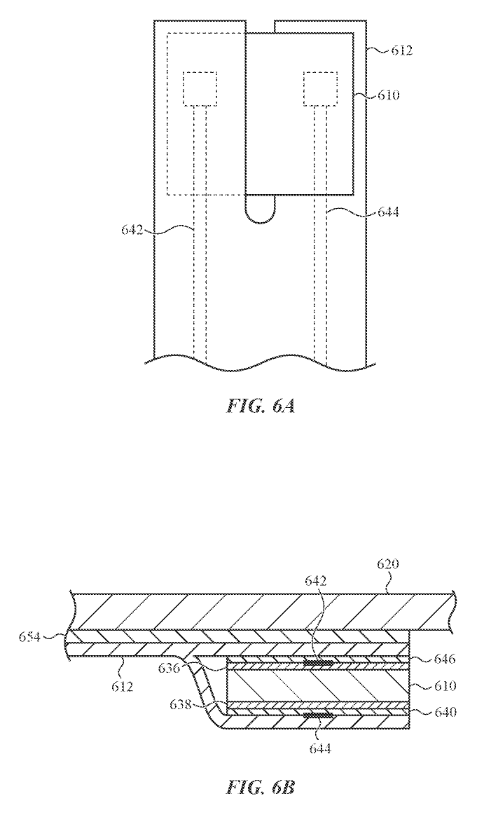

As depicted in FIGS. 6A-6B, in some embodiments a slave control flex 612 may be formed as a single piece which is split to couple directly to a top and bottom surface of a piezoelectric haptic actuator 610. FIG. 6A depicts a top view of a slave control flex 612 split across a top and bottom of a piezoelectric haptic actuator 610, while FIG. 6B depicts a cross-sectional view of a haptic actuator module incorporating the slave control flex 612 according to the same embodiment.

The slave control flex 612 depicted in FIGS. 6A and 6B may be formed as a single flexible circuit via an appropriate method such as described with respect to FIG. 3A. The slave control flex 612 is further cut or otherwise formed with a split. The slave control flex 612 includes a first conductor 642 configured to provide a control signal to a first electrode 636 on the top surface of the piezoelectric haptic actuator 610, and a second conductor 644 configured to provide a reference voltage level to a second electrode 638 on the bottom surface of the piezoelectric haptic actuator 610. In some embodiments, the roles of the conductors 642, 644 may be reversed.

In this embodiment, the first electrode 636 may be disposed across a substantial majority or the entirety of the top surface of the piezoelectric haptic actuator 610, and the second electrode 638 may be similarly disposed across a substantial majority or the entirety of the bottom surface of the piezoelectric haptic actuator 610.

The top surface of the piezoelectric substrate 610 may be coupled to a first portion of the slave control flex 612 having the first conductor 642. The piezoelectric substrate 610 is bonded to the first portion by an adhesive layer 646, which may be an isotropic conductive film. The isotropic conductive film of the adhesive layer 646 may facilitate conduction from the first conductor 642 in the slave control flex 612 to the first electrode 636 on the piezoelectric substrate 610.

The bottom surface of the piezoelectric substrate 610 is further coupled to a second portion of the slave control flex 612 having the second conductor 644. The piezoelectric substrate is bonded to the second portion by an additional adhesive layer 640, which may be an isotropic conductive film. The isotropic conductive film of the additional adhesive layer 640 may facilitate conduction from the second conductor 644 in the slave control flex 612 to the second electrode 638 on the piezoelectric substrate 610.

In this manner, the piezoelectric substrate 610 may be coupled and electrically connected to the slave control flex 612, providing conduction paths from control circuitry to the top surface and bottom surface of the piezoelectric substrate. In other embodiments, the piezoelectric substrate 610 may be coupled and electrically connected to the slave control flex 612 by anisotropic conductive film, anisotropic or isotropic conductive paste, or another appropriate method.

The slave control flex 612 is further coupled to a support structure 620 through an additional adhesive layer 654. The additional adhesive layer 654 may be any adhesive or bonding agent suitable for promoting adhesion between the slave control flex 612 and the support structure 620. In some embodiments, the additional adhesive layer 654 may be formed from a pressure-sensitive adhesive.

FIGS. 7A-7B depict example methods of attaching a slave control flex 712 to a master control flex 714. FIG. 7A depicts a first method of attaching a slave control flex 712 to a master control flex 714, in which a bottom surface of the slave control flex 712 is coupled to a top surface of the master control flex 714.

The slave control flex 712 may be formed as described above with respect to FIG. 3A. The slave control flex 712 includes a first conducting pad 742 and a second conducting pad 744 disposed on a bottom surface of the slave control flex 712. The first conducting pad 742 and second conducting pad 744 are electrically connected, respectively, to a first conductor and second conductor in the slave control flex 712 (such as the first conductor 542 and second conductor 544 depicted in FIGS. 5A, 5D, and 5G).

Similarly, the master control flex 714 may be formed as described above with respect to FIG. 3A. The master control flex 714 includes a reference voltage conducting pad 748 and a control signal conducting pad 748 disposed on a top surface of the master control flex 714. The reference voltage conducting pad 748 and control signal conducting pad 748 are electrically connected, respectively, to a reference voltage conductor and control signal conductor in the master control flex 714 (such as the reference voltage conductor 548 and control signal conductor 550 depicted in FIGS. 5A, 5D, and 5G).

Any suitable method can be used to attach the master control flex 714 to the slave control flex 312. For example, the conducting pads 748, 750 of the master control flex 714 may be attached to the conducting pads 742, 744 of the slave control flex 712 by reflow soldering to electrically connect the first conducting pad 742 to the control signal conducting pad 750, as well as to connect the second conducting pad 744 to the reference voltage conducting pad 748. In other embodiments, another attachment technique may be used, such as anisotropic conductive film, isotropic conductive film, ultrasonic welding, laser welding, and so on (see FIG. 10). In some embodiments, conducting pads 742, 744 may be formed on a top surface of the slave control flex 712, and conducting pads 748, 750 may be formed on a bottom surface of the slave control flex, which are attached by a similar method.

FIG. 7B depicts a second method of attaching a slave control flex 712 to a master control flex 714, in which a portion of the slave control flex 712 is attached to a top surface of the master control flex 714 and another portion of the slave control flex 712 is attached to a bottom surface of the master control flex 714.

The slave control flex 712 may be formed as described above with respect to FIG. 3A. The slave control flex 712 includes a first conducting pad 742 disposed on a bottom surface of the slave control flex 712 and a second conducting pad 744 disposed on a top surface of the slave control flex 712. The first conducting pad 742 and second conducting pad 744 are electrically connected, respectively, to a first conductor and second conductor in the slave control flex 712 (such as the first conductor 542 and second conductor 544 depicted in FIGS. 5A, 5D, and 5G). The slave control flex 712 is further cut or otherwise formed with a split, wherein a first portion of the slave control flex 712 includes the first conducting pad 742 and a second portion includes the second conducting pad 744.

The master control flex 714 may be formed as described above with respect to FIG. 3A. The master control flex 714 includes a reference voltage conducting pad 748 disposed on a bottom surface of the master control flex 714 and a control signal conducting pad 748 disposed on a top surface of the master control flex 714. The reference voltage conducting pad 748 and control signal conducting pad 748 are electrically connected, respectively, to a reference voltage conductor and control signal conductor in the master control flex 714 (such as the reference voltage conductor 548 and control signal conductor 550 depicted in FIGS. 5A, 5D, and 5G).

Any suitable method can be used to attach the master control flex 714 to the slave control flex 712. For example, the portion of the slave control flex 712 with the first conducting pad 742 may be coupled to the top surface of the master control flex 714 by reflow soldering to electrically connect the first conducting pad 742 to the control signal conducting pad 750. The portion of the slave control flex 712 with the second conducting pad 742 may be coupled to the bottom surface of the master control flex 714 by reflow soldering to electrically connect the second conducting pad 744 to the reference voltage conducting pad 748. In other embodiments, another attachment technique may be used, such as anisotropic conductive film, isotropic conductive film, ultrasonic welding, laser welding, and so on (see FIG. 10). In some embodiments, the conducting pads 742, 744 on the slave control flex 712 may be formed on opposite surfaces of the slave control flex 712, and the conducting pads 748, 750 on the master control flex 714 may be formed on opposite surfaces of the master control flex 714. In these embodiments, the master control flex 714 and slave control flex 712 are attached by a similar method.

In some embodiments, the slave control flex 712 and master control flex 714 may be attached and electrically connected by a removable connection. For example, the slave control flex 712 may be formed with a pin connector (e.g., a surface-mounted or edge-mounted pin connector) at a connection end, which may be electrically connected to a first conductor and second conductor in the slave control flex 712 (such as the first conductor 542 and second conductor 544 depicted in FIGS. 5A, 5D, and 5G). The master control flex 714 may be formed with a pin connector receiver (e.g., a surface-mounted pin connector receiver), which may be electrically connected to a reference voltage conductor and control signal conductor in the master control flex 714 (such as the reference voltage conductor 548 and control signal conductor 550 depicted in FIGS. 5A, 5D, and 5G). The pin connector may be coupled to the pin connector receiver, attaching and electrically connecting the slave control flex 712 with the master control flex 714.

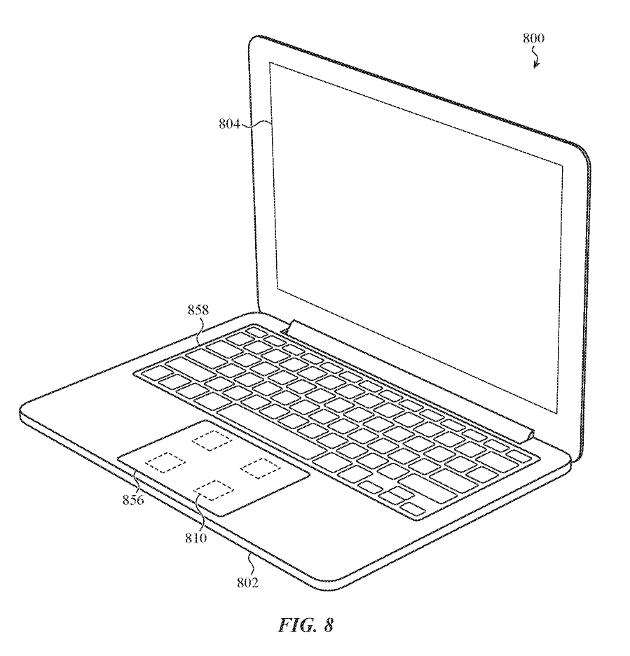

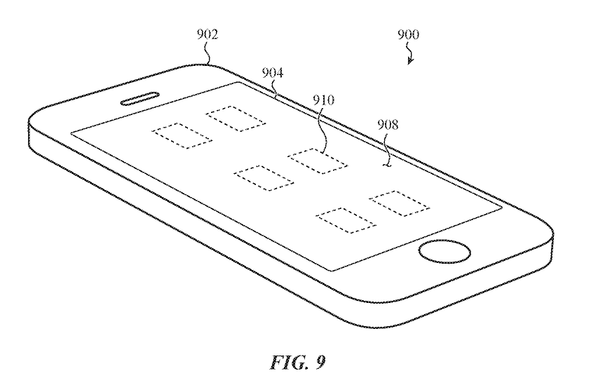

As illustrated in FIGS. 8-9, an array of haptic actuators according to the present invention may be implemented in many forms. An array of haptic actuators according according to the present invention may be implemented in a touch screen, keyboard, mouse, trackpad, or other input/output devices. The array of haptic actuators may further be incorporated into devices such as a laptop computer, as illustrated with respect to FIG. 8, or smaller electronic devices such as a cellular telephone as illustrated with respect to FIG. 9. The array of haptic actuators of the present invention may also be incorporated into separate multipurpose devices or accessories, such as a case for a portable electronic device.

FIG. 8 depicts a laptop computer 800 with a trackpad 856 incorporating an array of piezoelectric haptic actuators 810. The laptop computer 800 includes a housing 802, with an upper portion housing a display 804 and a lower portion housing a keyboard 858 and the trackpad 856. The array of haptic actuators 810 may provide localized haptic feedback across the input surface of the trackpad 856. The array of haptic actuators 810 may further receive control signals from a control circuit layer (including control circuitry, one or more master control flexes and one or more slave control flexes) as described above with respect to FIGS. 1A-7B.

FIG. 9 depicts a cellular telephone 900 with a cover sheet 908 over a display 904 and an array of piezoelectric haptic actuators 910. The cellular telephone includes a housing 902, enclosing the array of haptic actuators 910. The array of haptic actuators 910 may provide localized haptic feedback across the cover sheet 908. The array of haptic actuators 910 may further receive control signals from a control circuit layer (including control circuitry, one or more master control flexes and one or more slave control flexes) as described above with respect to FIGS. 1A-7B.

FIG. 10 depicts a flow diagram illustrating a method for coupling together components of a control circuit layer (e.g., a flexible circuit assembly). The method begins at operation 1002, where a master flexible member (e.g., master control flex, such as described above with respect to FIGS. 1A-9) is selected for bonding to at least one slave flexible member (e.g., slave control flex, such as described above with respect to FIGS. 1A-9).

At operation 1004, the master flex member is prepared for bonding. For example, a solder paste may be applied to conducting pads on the master flex member. In other embodiments, an adhesive, such as an isotropic or anisotropic conductive film, may be applied to a surface of the master flex member and/or conducting pads on the master flex member.

At operation 1006, a determination is made whether any additional master flex members are to be prepared for bonding. If additional master flex members are to be prepared for bonding, the process 1000 returns to operation 1002. If no additional master flex members are to be prepared, the process 1000 continues to operation 1008. In some embodiments, multiple master flex members can be selected at operation 1002, including all master flex members to be bonded, and operation 1006 may be omitted.

At operation 1008, a slave flexible member is selected for bonding to a prepared master flexible member. At operation 1010, the slave flexible member is aligned with the master flexible member. In some examples, the slave flexible member may be aligned by a surface mount component placement system (i.e., a pick and place machine) by aligning conducting pads on the slave flexible member with corresponding conducting pads on the master flexible member. The conducting pads may be held together by the solder paste or a similar bonding agent, which may form a temporary bond.

At operation 1012, a determination is made whether any additional slave flex members are to be bonded to a master flex member. If additional slave flex members are to be bonded, the process 1000 returns to operation 1008. If no additional master flex members are to be bonded, the process 1000 continues to operation 1014.

At operation 1014, the slave flex member(s) are coupled to the master flex member(s). For example, the temporary bond formed by the solder paste or similar bonding agent may be strengthened and/or made permanent by heat. The slave flex member(s) and master flex member(s) may be placed in a reflow oven or similar device to heat the solder paste and form a permanent solder bond. In other embodiments, an adhesive may be placed under pressure and/or heat to form a permanent bond.

At operation 1016, one or more piezoelectric modules may be selected for bonding to corresponding slave flex member(s). The piezoelectric module(s) may be a piezoelectric substrate with electrodes formed on one or more surfaces, such as described above with respect to FIGS. 1A-9.

At operation 1018, the slave flex member(s) are prepared for bonding to the piezoelectric module(s). For example, an anisotropic conductive film may be applied across a surface of the slave flex member(s), over conducting pad(s) on the slave flex member(s). In other embodiments, a solder paste or another adhesive, such as an isotropic conductive film, may be applied to a surface of the slave flex member and/or conducting pads on the slave flex member.

At operation 1020, the slave flex member(s) are coupled to the piezoelectric module(s). For example, the slave flex member(s) with anisotropic conductive film may be placed on a surface of the piezoelectric module(s), forming a bond between the piezoelectric module(s) and the slave flex member(s) and electrically connecting the conducting pad(s) on the slave flex member(s) with one or more electrodes on the surface of the piezoelectric module(s). In some embodiments, the piezoelectric module(s) are aligned by a surface mount component placement system (i.e., a pick and place machine) by aligning the electrode(s) on the surface of the piezoelectric module(s) with the conducting pad(s) on the slave flexible member. In some embodiments, the bond of the anisotropic conductive film may be strengthened by heat and/or pressure, though this is not required.

One may appreciate that although many embodiments are disclosed above, that the operations and steps presented with respect to methods and techniques described herein are meant as exemplary and accordingly are not exhaustive. One may further appreciate that alternate step order or fewer or additional operations may be required or desired for particular embodiments.

FIG. 11 depicts example components of an electronic device in accordance with the embodiments described herein. The schematic representation depicted in FIG. 11 may correspond to components of the devices depicted in FIGS. 1-10, described above. However, FIG. 11 may also more generally represent other types of electronic devices with an array of haptic actuators 1110 configured to provide localized haptic feedback.

As shown in FIG. 11, a device 1100 includes a processing unit 1160 operatively connected to computer memory 1162. The processing unit 1160 may be operatively connected to the memory 1162 component via an electronic bus or bridge. The processing unit 1160 may include one or more computer processors or microcontrollers that are configured to perform operations in response to computer-readable instructions. The processing unit 1160 may be the central processing unit (CPU) of the device 1100. Additionally or alternatively, the processing unit 1160 may include other processors within the device 1100 including application specific integrated chips (ASIC) and other microcontroller devices. The processing unit 1160 may be configured to perform functionality described in the examples above.

The memory 1162 may include a variety of types of non-transitory computer-readable storage media, including, for example, read access memory (RAM), read-only memory (ROM), erasable programmable memory (e.g., EPROM and EEPROM), or flash memory. The memory 1162 is configured to store computer-readable instructions, sensor values, and other persistent software elements. In some embodiments, the memory 1162 is additionally connected to control circuitry 1116.

In this example, the processing unit 1160 is operable to read computer-readable instructions stored on the memory 1162. The computer-readable instructions may adapt the processing unit 1160 and/or control circuitry 1116 to perform the operations or functions described above with respect to FIGS. 1-10. The computer-readable instructions may be provided as a computer-program product, software application, or the like.

The device 1100 may also include a battery 1166 that is configured to provide electrical power to the components of the device 1100. The battery 1166 may include one or more power storage cells that are linked together to provide an internal supply of electrical power. The battery 1166 may be operatively coupled to power management circuitry that is configured to provide appropriate voltage and power levels for individual components or groups of components within the device 1100. The battery 1166, via power management circuitry, may be configured to receive power from an external source, such as an alternating current power outlet. The battery 1166 may store received power so that the device 1100 may operate without connection to an external power source for an extended period of time, which may range from several hours to several days.

In some embodiments, the device 1100 includes one or more input devices 1168. The input device 1168 is a device that is configured to receive user input. The input device 1168 may include, for example, a push button, a touch-activated button, or the like. In some embodiments, the input devices 1168 may provide a dedicated or primary function, including, for example, a power button, volume buttons, home buttons, scroll wheels, and camera buttons. Generally, a touch sensor and a force sensor may also be classified as input components. However, for purposes of this illustrative example, the touch sensor 1170 and force sensor 1122, 1124 are depicted as distinct components within the device 1100.

The device 1100 may also include a touch sensor 1170 that is configured to determine a location of a finger or touch over the adaptable input surface of the device 1100. The touch sensor 1170 may be implemented in a touch sensor layer, and may include a capacitive array of electrodes or nodes that operate in accordance with a mutual-capacitance or self-capacitance scheme.

The device 1100 may also include a force sensor 1122, 1124 in accordance with the embodiments described herein. As previously described, the force sensor 1122, 1124 may be configured to receive force touch input over the adaptable input surface of the device 1100. The force sensor 1122, 1124 may also be implemented in a touch-sensing layer, and may include one or more force-sensitive structures that are responsive to a force or pressure applied to an external surface of the device. In accordance with the embodiments described herein, the force sensor 1122, 1124 may be configured to operate using a dynamic or adjustable force threshold. The dynamic or adjustable force threshold may be implemented using the processing unit 1160 and/or circuitry associated with or dedicated to the operation of the force sensor 1122, 1124.

The device 1100 may also include a haptic actuator 1110. The haptic actuator 1110 may be implemented as described above, and may be a ceramic piezoelectric transducer. The haptic actuator 1110 may be controlled by control circuitry 1116, and may be configured to provide localized haptic feedback to a user interacting with the device 1100.

The control circuitry 1116 is configured to control the generation of electrical control signals for the array of piezoelectric haptic actuators 1110. The control circuitry 1116 can be implemented as any electronic device capable of processing, receiving, or transmitting data or instructions. For example, the control circuitry 1116 can be a microprocessor, a central processing unit (CPU), an application-specific integrated circuit (ASIC), a digital signal processor (DSP), or combinations of multiple such devices. In some embodiments, the control circuitry 1116 can be formed as part of the processing unit 1160.

The memory 1162 can store electronic data that can be used by the control circuitry 1116. For example, the memory 1162 can store electrical data or content, such as timing signals, algorithms, and one or more different electrical signal characteristics that the control circuitry 1116 can use to produce one or more electrical signals. The electrical signal characteristics include, but are not limited to, an amplitude, a phase, a frequency, and/or a timing of an electrical signal.

The device 1100 may also include a communication port 1164 that is configured to transmit and/or receive signals or electrical communication from an external or separate device. The communication port 1164 may be configured to couple to an external device via a cable, adaptor, or other type of electrical connector. In some embodiments, the communication port 1164 may be used to couple the device 1100 to a host computer.

The foregoing embodiments relate to an electronic device that is configured to provide localized haptic feedback to a user on one or more surfaces of the electronic device. In further embodiments, the haptic feedback surface can also include one or more user input regions (e.g., user input surface) which receives user touch and force inputs. More specifically, a user may interact with the input device by touching within the user input region. The user may further interact with the input device by applying varying amounts of force at the touch location. In these examples, a sensor structure positioned below the user input region may detect both the location of the touch and estimate the amount of force applied to the user input region in a unified structure.

The sensor structure may incorporate a ground electrode and sensing electrodes separated by a piezoelectric substrate. With regard to touch detection, the piezoelectric substrate may operate as a dielectric layer and the sensor structure may detect a location of a touch by capacitive touch sensing using the ground electrode and/or sensing electrodes. With regard to force detection, the application of force on the user input region may cause the piezoelectric substrate to compress, which in turn may create a charge on a sensing electrode and/or ground electrode. The charge on the sensing electrode and/or ground electrode may be measured and an amount of force may be estimated.

In a particular embodiment the input device may be in the form of a trackpad. The trackpad may form part of a laptop computing device. The trackpad may include a user input region with a cover sheet for receiving user inputs. The sensor structure may be positioned below the cover sheet. The sensor structure includes a piezoelectric substrate and a ground electrode may be attached below the piezoelectric substrate. A sensing layer is attached above the piezoelectric substrate.

The sensing layer includes a patterned array of electrodes disposed within a flexible substrate. The patterned array of electrodes includes rows of drive electrodes and columns of sense electrodes. The drive electrodes and sense electrodes are in a coplanar arrangement. The pattern of drive and sense electrodes operate in a capacitive touch scheme to detect a location of a touch on the input surface, and may detect multiple locations corresponding to multiple touches at a time. The drive and sense electrodes also operate with the piezoelectric substrate to form force sensors that are configured to estimate an amount of force of the touch on the input surface.

In another embodiment, the sensor structure may additionally provide haptic feedback at the user input region. To cause haptic feedback, a signal is applied to the sense layer to create a potential across the piezoelectric substrate. The potential causes an expansion of the piezoelectric substrate, causing a tensile force within the sensor structure. The tensile force is translated to the user input region, causing haptic feedback at the cover sheet (e.g., user input surface).

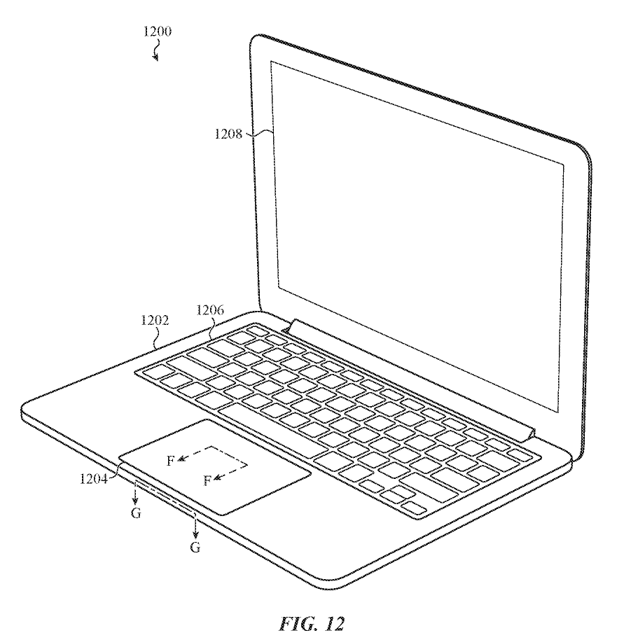

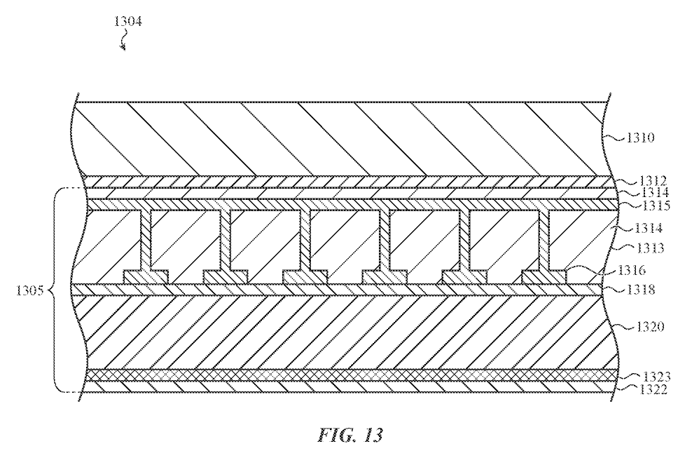

These and related embodiments are discussed below with reference to FIGS. 12-18. However, those skilled in the art will readily appreciate that the detailed description given herein with respect to these Figures is for explanatory purposes only and should not be construed as limiting.

FIG. 12 depicts an isometric view of an electronic device having a sensor structure according to the present invention. In the illustrated embodiment, the electronic device 1200 is implemented as a laptop computing device. Other embodiments can implement the electronic device differently. For example, an electronic device can be a mobile device (e.g., smart phone, a tablet computing device, a wearable computing device, or a digital music player), a kiosk, a stand-alone touch screen display, a mouse, a keyboard, an electronic musical instrument, and other types of electronic devices that are configured to receive touch and/or force inputs from a user.

The electronic device 1200 includes an enclosure 1202 at least partially surrounding a display 1208 and an array of keys 1206. One or more user input regions (e.g., user input surface) 1204 are disposed adjacent the array of keys 1206. The enclosure 1202 can form an outer surface or partial outer surface for the internal components of the electronic device 1200. The enclosure 1202 can be formed of one or more components operably connected together, such as a front piece and a back piece. Alternatively, the enclosure 1202 can be formed of a single piece operably connected to the display 1208 with one or more openings for the array of keys 1206.

The display 1208 can provide a visual output to the user. The display 1208 can be implemented with any suitable technology, including, but not limited to, a liquid crystal display (LCD) element, a light emitting diode (LED) element, an organic light-emitting display (OLED) element, an organic electroluminescence (OEL) element, and the like. In some embodiments, the display 1208 can function as an input device that allows the user to interact with the electronic device 1200. For example, the display can be a multi-touch and/or multi-force sensing touchscreen LED display.

In some embodiments, the user input region 1204 can take the form of a trackpad which may accept user inputs and/or provide haptic output to a user. Further, in some embodiments, the user input region 1204 can include a cover sheet defining a user input surface. The user input region 1204 can be integrated with the enclosure 1202 of the electronic device 1200, or it may be attached to the enclosure 1202.

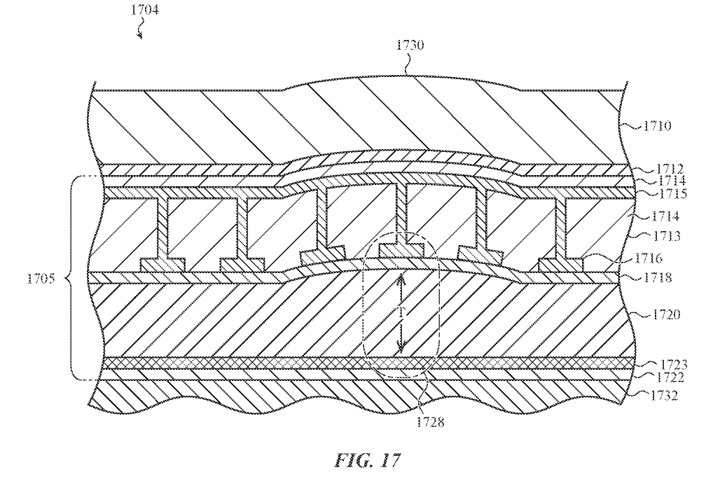

A sensor structure may be positioned below the user input region 1204, and may detect both touch and force input (see FIGS. 13-16). In some embodiments, the sensor structure may also provide haptic feedback at the user input region 1204 (see FIG. 17).

For example, the user input region 1204 may be a trackpad with a sensor structure configured to detect both touch and force input. The sensor structure may be a combined touch and force sensor using a piezoelectric substrate, which may further provide pixelated force and touch sensing across the input surface of the user input region 1204.

In some cases, the user input region 1204 may be configurable (e.g., by a user or software application) to provide force and/or touch sensing at distinct portions of the user input region 1204. The pixelated force and touch sensing may be provided by a set of sense and drive electrodes disposed on a piezoelectric substrate and coupled to touch sensing circuitry and force sensing circuitry. The touch sensing circuitry and force sensing circuitry may be configurable to provide separate touch sensing portions, force sensing portions, and combined touch and force sensing portions of the user input region 1204. Force sensing may also be configurable such that varying levels of force provide varying inputs to the device.

For example, a user or application may define a virtual joystick, gamepad, or other controller over a configurable user input region 1204. This may include a touch-sensitive portion of the user input region 1204 to simulate axial motion of a joystick, and a force-sensitive portion of the user input region 1204 to simulate one or more button inputs. In other examples, the configurable user input region 1204 may define a remote control, musical keyboard, keypad, and so on through configurable touch- and force-sensitive portions of the user input region 1204.

In other embodiments, the user input region 1204 may form a touch- and force-sensitive keyboard, a touch- and force-sensitive mouse, or other electronic devices as described above. In these embodiments, the user input region 1204 may similarly provide distinct touch-sensitive portions, force-sensitive portions, and touch- and force-sensitive portions. These portions may further be configurable by a user or software application.

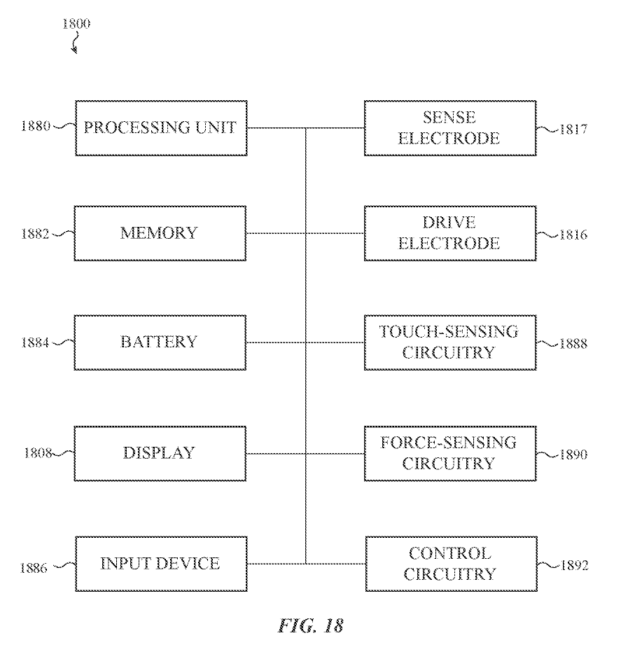

Although not shown in FIG. 12, the electronic device 1200 can include other types of 110 devices, such as a microphone, a speaker, a camera, a headphone, a biometric sensor, and one or more ports, such as a network communication port and/or a power cord port. The electronic device 1200 may include other components, such as illustrated in FIG. 18.

FIG. 13 depicts a simplified cross-sectional view of the electronic device of FIG. 12 taken along line F-F, illustrating a stack-up of the sensor structure 1305. In some embodiments, the user input region 1304 includes a cover sheet 1310 positioned over a sensor structure 1305. The user input region 1304 may include a user input surface through which a user may interact with the electronic device.

The cover sheet 1310 may be attached to the sensor structure 1305 by an adhesive layer 1312. The sensor structure 1305 may include further layers, such as a piezoelectric substrate 1320 between a ground electrode 1322 and a sensing layer 1313. The sensing layer 1313 may include electrodes 1316 coupled to conducting elements 1315. As shown in FIG. 13, the conducting elements 1315 may be located on a different plane, or otherwise at a different height or depth, from the electrodes 1316 and connected thereto by vias. The sensing layer 1313 and the ground electrode 1322 may be bonded to the piezoelectric substrate 1320 by adhesive layers 1318, 1323. It should be understood that additional or fewer layers may be included within the scope of the disclosure. Further, the relative position of the various layers may change depending on the embodiment.

The cover sheet 1310 can function as an input surface that receives touch and/or force inputs. The cover sheet 1310 can be formed with any suitable material, such as plastic, polymer, glass, sapphire, or combinations thereof. In certain embodiments, the cover sheet 1310 may also provide haptic feedback to a user in contact with the cover sheet 1310 (see FIG. 17).

The cover sheet 1310 may be attached to the sensor structure 1305 (e.g., via the sensing layer 1313) through a first adhesive layer 1312. The first adhesive layer 1312 may be any adhesive or bonding agent suitable for promoting adhesion between the cover sheet 1310 and the sensor structure 1305. In some embodiments, the adhesive layer 1312 may be formed from a pressure-sensitive adhesive.

The sensor structure 1305 may include a sensing layer 1313. The sensing layer 1313 may be the portion of the sensor structure 1305 which attaches to the cover sheet 1310. In other embodiments, there may be additional layers between the cover sheet 1310 and the sensing layer 1313. The sensing layer 1313 may include a flexible substrate 1314. The flexible substrate 1314 may be formed from a suitable material, for example polyimide, polyethylene terephthalate (PET) or cyclo-olefin polymer (COP).

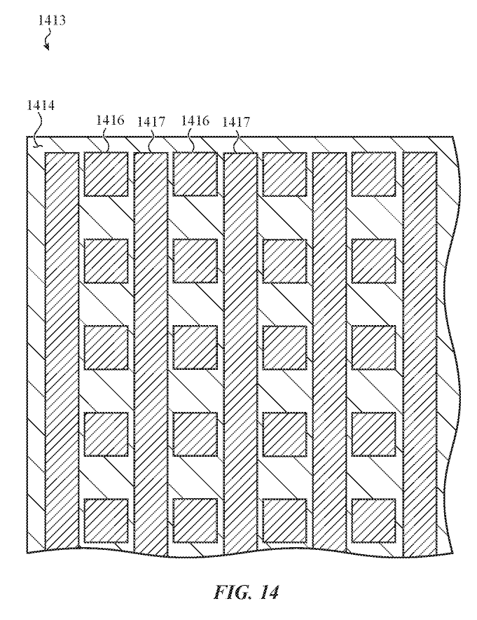

An array of electrodes 1316 may be positioned at a surface of the sensing layer 1313. The array of electrodes 1316 may be a patterned array of drive electrodes and sense electrodes, as further illustrated below with respect to FIG. 14, and may be disposed within the flexible substrate 1314. The array of electrodes 1316 may be interconnected by conducting elements 1315. The conducting elements 1315 may further connect the electrodes 1316 to sensing circuitry and/or other components of the electronic device (see FIG. 18).

The array of electrodes 1316 and conducting elements 1315 may be formed by depositing or otherwise affixing a conductive material to the flexible substrate 1314. In some embodiments, the electrodes 1316 and conducting elements 1315 may be conductive pads, traces and/or vias formed integral with the flexible substrate 1314. The electrodes 1316 and conducting elements 1315 may be formed from a suitable material, such as metals (e.g., copper, gold, silver, aluminum), polyethyleneioxythiophene (PEDOT), indium tin oxide (ITO), carbon nanotubes, graphene, piezoresistive semiconductor materials, piezoresistive metal materials, silver nanowire, other metallic nanowires, and the like.

The array of electrodes 1316 may be placed on a surface of the sensing layer 1313 adjacent a piezoelectric substrate 1320. The sensing layer 1313 may be bonded to the piezoelectric substrate 1320 by a second adhesive layer 1318. The second adhesive layer 1318 may be any adhesive or bonding agent suitable for promoting adhesion between the sensing layer 1313 and the piezoelectric substrate 1320. The second adhesive layer 1318 may be formed from a similar adhesive to the first adhesive layer 1312, while in other embodiments the two adhesive layers 1312, 1318 may be formed from distinct materials. In still other embodiments, the sensing layer 1313, or a portion thereof, may be formed directly on the piezoelectric substrate 1320 (e.g., by depositing the array of electrodes 1316 on the piezoelectric substrate 1320).

The piezoelectric substrate 1320 may also be attached to a ground electrode 1322. The ground electrode 1322 may attach to a side of the piezoelectric substrate 1320 opposite the sensing layer 1313. A third adhesive layer 1323 may attach the piezoelectric substrate 1320 and the ground electrode 1322. The third adhesive layer 1323 may be formed from a suitable adhesive or bonding agent (e.g., the same or a different material as the first adhesive layer 1312 or second adhesive layer 1318). In some embodiments, the ground electrode 1322 may be deposited directly on the piezoelectric substrate 1320.

The ground electrode 1322 may be formed from a suitable material, such as metals (e.g., copper, gold, silver, aluminum), polyethyleneioxythiophene (PEDOT), indium tin oxide (ITO), carbon nanotubes, graphene, piezoresistive semiconductor materials, piezoresistive metal materials, silver nanowire, other metallic nanowires, and the like. The ground electrode 1322 may be formed from the same or a different material from the array of electrodes 1316 in the sensing layer 1313. In some embodiments, the ground electrode 1322 is formed as a single large electrode (e.g., an electrode spanning concurrent with the user input region 1304), while in other embodiments the ground electrode 1322 is formed from multiple coplanar electrodes.

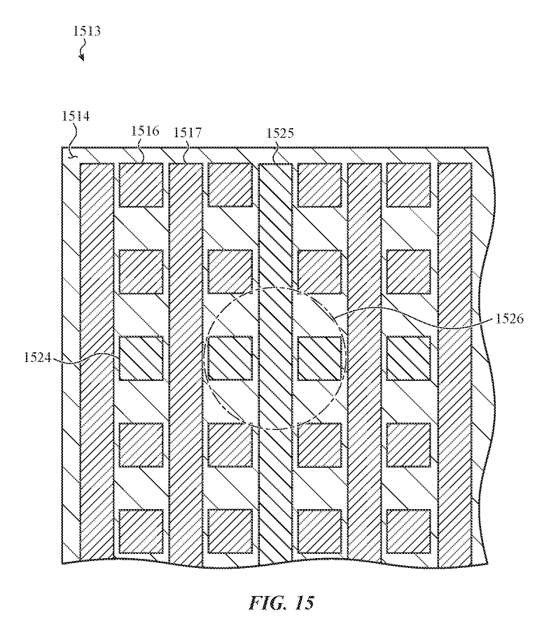

The piezoelectric substrate 1320 may be formed from a suitable material, such as a ceramic piezoelectric material. Example materials include lead zirconate titanate (PZT), lead titanate, quartz, sodium potassium niobate, bismuth ferrite, polyvinylidene fluoride (PVDF), and other suitable piezoelectric materials. The piezoelectric substrate 1320 may be a dielectric material suitable for forming a capacitor, such as a capacitive touch sensor (see FIGS. 14-15).

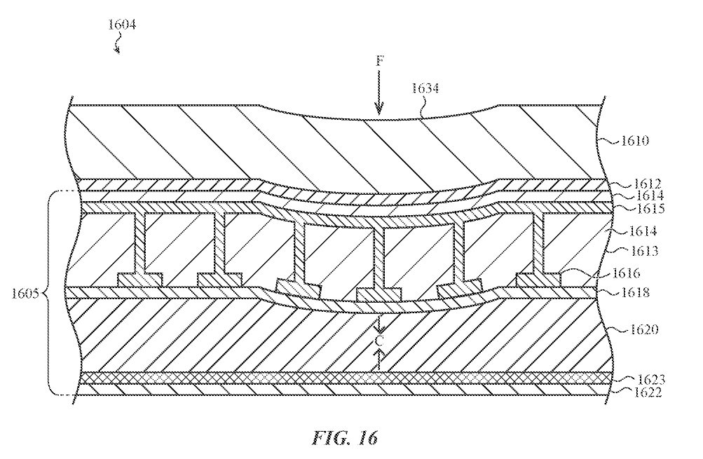

The piezoelectric substrate 1320 may also be a crystalline material having an electrical response upon alteration of its physical structure. For example, a charge may accumulate on or near a surface of the piezoelectric substrate 1320 when it is compressed, which may cause production of an electrical signal that may correspond linearly to the amount of force causing the compression (see FIG. 16).

In some embodiments, the piezoelectric substrate 1320 may additionally or alternatively alter its physical structure in response to application of an electrical potential across the piezoelectric substrate 1320. For example, when a voltage is applied across the piezoelectric substrate 1320, the voltage may induce the piezoelectric substrate 1320 to expand or contract (see FIG. 17).

Turning in more detail to the sensing layer 1413, FIG. 14 depicts a simplified cross-sectional view of the electronic device of FIG. 12 taken along line G-G, illustrating the sensing layer 1413 of the sensor structure. The sensing layer 1413 includes an array of sense electrodes 1417 arranged in columns and drive electrodes 1416 arranged in rows. The sense electrodes 1417 and drive electrodes 1416 are disposed within a flexible substrate 1414. The sensing layer 1413 may be formed from materials substantially as described above with respect to FIG. 13.

The sense electrodes 1417 and drive electrodes 1416 are substantially coplanar. The sense electrodes 1417 extend the length of a column, which may substantially correspond with a length of the input region shown in FIG. 12. Due to the coplanar arrangement of the electrodes, the drive electrodes 1416 are disposed between the sense electrodes 1417 to prevent short circuits. The drive electrodes 1416 in each row may be coupled (e.g., electrically connected) together, and may be coupled by conductive elements, vias, or the like (e.g., the conducting elements 1315 shown in FIG. 13). These connections are omitted from FIG. 14 for clarity, but may be seen in FIG. 13 as one example.

In some embodiments, the drive electrodes 1416 and sense electrodes 1417 may be non-coplanar or otherwise differently arranged. For example, the drive electrodes 1416 and sense electrodes 1417 may be disposed in separate layers. In some cases sense electrodes 1417 may extend the length of a column and drive electrodes 1416 may extend the length of a row in overlapping layers. In some examples, the sense electrodes 1417 may be arranged in rows while the drive electrodes are arranged in columns. In other examples, the drive electrodes 1416 and sense electrodes 1417 may be formed in other grid patterns, such as rectangular, square, circular, triangular, and other geometric patterns, including non-regular geometric patterns.

The sense electrodes 1417 and drive electrodes 1416 are configured to detect the location of a finger or object on or near the cover sheet of the input region. The sense electrodes 1417 and drive electrodes 1416 may further be configured to detect the location of multiple fingers or objects concurrently. The sense electrodes 1417 and drive electrodes 1416 may operate in accordance with a number of different sensing schemes. In some implementations, the sense electrodes 1417 and drive electrodes 1416 may operate in accordance with a mutual-capacitance sensing scheme. Under this scheme, the sense electrodes 1417 and drive electrodes 1416 may operate in conjunction with another electrode (e.g., the ground electrode 1322 of FIG. 13) on a different plane, with a dielectric layer (e.g., the piezoelectric substrate 1320 of FIG. 13) disposed therebetween.

Under a mutual capacitance sensing scheme, the sense electrodes 1417 and drive electrodes 1416 are configured to detect the location of a touch by monitoring a change in capacitive or charge coupling between the ground electrode and an intersecting sense electrode 1417 and row of drive electrodes 1416. This is further illustrated below with respect to FIG. 15.

In another implementation, the sense electrodes 1417 and drive electrodes 1416 may operate in accordance with a self-capacitive sensing scheme. Under this scheme, the sense electrodes 1417 and drive electrodes 1416 may be configured to detect the location of a touch by monitoring a change in self-capacitance of a small field generated by each electrode. In other implementations, a resistive, inductive, or other sensing scheme could also be used.

The sense electrodes 1417 and drive electrodes 1416 of the sensing layer 1413 may be operably coupled (e.g., electrically connected) to touch sensing circuitry to form touch sensors. The touch sensing circuitry may be configured to detect and estimate the location of a touch on or near the user input region (e.g., user input surface). The touch sensing circuitry may further output signals or other indicia indicating the detected location of a touch. The touch sensing circuitry may be operably coupled to a processing unit as depicted below with respect to FIG. 18, and in some embodiments may be integrated with the processing unit.

The sense electrodes 1417 and drive electrodes 1416 may also be coupled with a piezoelectric substrate (e.g., the piezoelectric substrate 1320 of FIG. 13) and a ground electrode (e.g., the ground electrode 1322 of FIG. 13) to form a force sensor, or an array of force nodes. The force nodes may be used to estimate the magnitude of force applied by one or multiple touches on the cover sheet. Both force sensing and touch sensing may be achieved using the same sense electrodes 1417, drive electrodes 1416, piezoelectric substrate, and ground electrode.

Each force node may be formed from pairing a sense electrode 1417 and/or drive electrode 1416 with a ground electrode on an opposite side of a block of piezoelectric substrate. Alternatively, each force node may be formed from an individual block of piezoelectric material that is electrically coupled to sensing circuitry. The operation of the sensor structure for force sensing is further illustrated below with respect to FIG. 16.

The arrangement and density of the force nodes may vary depending on the implementation. For example, if not necessary to resolve the force for each of multiple touches on the cover sheet, the force nodes may comprise a single force node. However, in order to estimate the magnitude of force of each of multiple touches on the cover sheet, multiple force nodes may be used. The density and size of the force nodes will depend on the desired force-sensing resolution. Additionally or alternatively, the force nodes may be used to determine both the location and the force applied to the cover sheet. The force sensors may further be configured to send a signal or otherwise respond to the detection of an amount of force exceeding a defined threshold.

The force nodes may be operably coupled to force sensing circuitry to form force sensors. The force sensing circuitry may be configured to detect and estimate an amount of force applied to the cover sheet. In some embodiments, the force sensing circuitry may further detect a location of an applied force. The force sensing circuitry may further output signals or other indicia indicating an estimated amount of applied force. In some embodiments, the force sensing circuitry may include one or more thresholds, and may only output signals in accordance with an applied force exceeding a threshold. The force sensing circuitry may be operably coupled to a processing unit as depicted below with respect to FIG. 18, and in some embodiments may be integrated with the processing unit. In some embodiments, the force sensing circuitry and the touch sensing circuitry may be formed as combined force-and-touch sensing circuitry.

The force sensing circuitry and/or touch sensing circuitry may further be configurable to provide distinct touch-sensitive regions, force-sensitive regions, and/or force- and touch-sensitive regions at the cover sheet. For example, a touch-sensitive region may be defined over a particular set of drive electrodes 1416 and sense electrodes 1417, while a force-sensitive region may be defined over another set of drive electrodes 1416 and sense electrodes 1417.

For example, a user or application may define a virtual joystick, gamepad, or other controller over the cover sheet. This may include a touch-sensitive region to simulate axial motion of a joystick, and a force-sensitive region to simulate one or more button inputs. In other examples, a keyboard may be defined over the cover sheet having separate touch- and force-sensitive regions. The keyboard may further define keys over distinct regions of the cover sheet, with varying force input thresholds. These varying force input thresholds may allow a same region (or virtual key) to input different alphanumeric symbols in response to different amounts of force on that region.

The operation of the sensing layer 1513 for detecting touch is further illustrated in FIG. 15. FIG. 15 depicts a simplified cross-sectional view of the electronic device of FIG. 12 taken along line G-G illustrating the sensing layer 1513 of the sensor structure in response to detection of a touch. The sensing layer 1513 includes an array of sense electrodes 1517 arranged in columns and drive electrodes 1516 arranged in rows. The sense electrodes 1517 and drive electrodes 1516 are disposed within a flexible substrate 1514. The sensing layer 1513 may be substantially as described above with respect to FIGS. 13 and 14.

The sense electrodes 1517 and drive electrodes 1516 are configured to detect the location of a finger 1526 or object on or near the cover sheet of the input region. The sense electrodes 1517 and drive electrodes 1516 may operate in accordance with a mutual-capacitance sensing scheme. Under this scheme, the sense electrodes 1517 and drive electrodes 1516 may operate in conjunction with another electrode (e.g., the ground electrode 1322 of FIG. 13) on a different plane, with a dielectric layer (e.g., the piezoelectric substrate 1320 of FIG. 13) disposed therebetween.

For example, the sense electrodes 1517 and drive electrodes 1516 may normally be biased with a voltage. Touch sensing circuitry (such as shown below with respect to FIG. 18) may be connected to sense electrode columns 1517 and rows of drive electrodes 1516. The touch sensing circuitry may monitor an electrical response of the sense electrodes 1517 and drive electrodes 1516, such as voltage.

An object may approach or make contact with the cover sheet of the user input region at a particular location 1526. In response to the contact, sense electrodes 1517 and drive electrodes 1516 within the touch region 1526 may have an electrical response. For example, where the sense electrodes 1517 and drive electrodes 1516 are biased with a voltage, the voltage may change in response to the touch (e.g., a charge may be discharged into the finger).

As depicted in FIG. 15, a user's finger contacts the user input region at a location 1526. The touch location 1526 intersects with a particular sense electrode 1525 and a particular row of connected drive electrodes 1524. In response to the contact at the touch location 1526, the particular sense electrode 1525 and the particular row of connected drive electrodes 1524 have an electrical response (e.g., a reduction in voltage). The touch sensing circuitry may detect the electrical response and determine the location of the touch as the location where the particular sense electrode 1525 and particular row of connected drive electrodes 1524 intersect.

Returning to the stack-up of the sensor structure, FIG. 16 illustrates the operation of the sensor structure 1605 for detecting force. FIG. 16 depicts a simplified cross-sectional view of the electronic device of FIG. 12 taken along line F-F, illustrating a stack-up of the sensor structure in response to an applied force.

The user input region 1604 includes a cover sheet 1610 positioned above a sensor structure 1605. The sensor structure 1605 may be substantially as described above with respect to FIG. 13, including a piezoelectric substrate 1620 between a ground electrode 1622 and a sensing layer 1613. The sensing layer 1613 may include electrodes 1616, coupled to conducting elements 1615. The electrodes 1616 may be a patterned array of electrodes 1616 substantially as described above with respect to FIG. 14.

One or more electrodes 1616 in the sensing layer 1613, the piezoelectric substrate 1620, and the ground electrode 1622 may form a force sensor. The force sensor may be used to estimate the magnitude of force applied by a touch on the cover sheet 1610. The piezoelectric substrate 1620 may have an electrical response to an alteration of its physical structure.

For example, when the piezoelectric substrate 1620 is compressed, a charge may be formed on or near a surface of the piezoelectric substrate 1620. The charge may in turn cause an electrical response on the electrodes 1616 in the sensing layer 1613 and/or ground electrode 1622 (e.g., an increase in electrical potential or voltage between the electrodes 1616 in the sensing layer 1613 and the ground electrode 1622). The electrodes 1616 in the sensing layer 1613 and/or ground electrode 1622 may be operably coupled (e.g., electrically connected) to force sensing circuitry (such as shown below with respect to FIG. 18). The force sensing circuitry may monitor an electrical response, such as the voltage between the electrodes 1616 in the sensing layer 1613 and the ground electrode 1622.

An object, such as a finger, may apply a force F to the cover sheet 1610 of the user input region 1604 at a particular location 1634. The force F may cause a deflection in the cover sheet 1610 at the location 1634 of the applied force F. This deflection may cause the force F to propagate through the cover sheet 1610, the first adhesive layer 1612, the sensing layer 1613, and the second adhesive layer 1618 to the piezoelectric substrate 1620.

In response to the propagated force, the piezoelectric substrate 1620 may be placed under a corresponding compression C at a location corresponding to the location 1634 of the applied force F. The compression C may cause an electrical response (e.g., an increased voltage across the piezoelectric substrate 1620) which can be detected at the electrodes 1616 in the sensing layer 1613 and/or the ground electrode 1622.

The electrical response in the piezoelectric substrate 1620 to the compression C may be proportional to the applied force F, and force sensing circuitry may estimate an amount of the applied force F based on the electrical response. The electrical response may further be localized to electrodes 1616 corresponding to the location 1634 of the applied force F. This may allow force sensing circuitry to additionally determine the location of the applied force, and may additionally allow for the detection of multiple force inputs concurrently. In other embodiments, the electrical response may be diffused across the piezoelectric substrate. In such embodiments, force sensing circuitry and touch sensing circuitry may be operated in conjunction to determine the location of one or multiple force inputs.

In some embodiments, the piezoelectric substrate 1620 and ground electrode 1622 may span the user input region 1604. In other embodiments, the piezoelectric substrate 1620 and ground electrode 1622 may be larger or smaller. For example, in certain embodiments the piezoelectric substrate 1620 and/or ground electrode 1622 may be an array of piezoelectric substrates 1620 and/or ground electrodes 1622.

For example, in order to better estimate the magnitude of force of each of multiple touches on the cover sheet 1610, the piezoelectric substrate 1620 may be divided into multiple coplanar substrates. The ground electrode 1622 may be similarly divided into multiple electrodes. However, a single piezoelectric substrate 1620 and single ground electrode 1622 are sufficient to achieve a unified multi-touch and multi-force sensor according to the present disclosure.

As depicted in FIG. 17, the sensor structure described in FIGS. 12-16 may additionally or alternatively be operated to produce haptic feedback to a user. FIG. 17 depicts a simplified cross-sectional view of the electronic device of FIG. 12 taken along line F-F, illustrating a stack-up of the sensor structure 1705 producing a haptic output on a location 1730 of a user input region 1704.

The user input region 1704 includes a cover sheet 1710 positioned above a sensor structure 1705. The sensor structure 1705 may be substantially as described above with respect to FIG. 13, including a piezoelectric substrate 1720 between a ground electrode 1722 and a sensing layer 1713. The sensing layer 1713 may include electrodes 1716, coupled to conducting elements 1715. The electrodes 1716 may be a patterned array of electrodes 1716 substantially as described above with respect to FIG. 14.

In the embodiment depicted in FIG. 17, the sensor structure 1705 forms a haptic element. A piezoelectric substrate 1720 is attached to the sensing layer 1713 (e.g., the circuit layer), e.g., through the second adhesive layer 1718. The sensing layer 1713 includes conducting elements 1715 (e.g., signal lines) that are electrically connected to the electrodes 1716. The conducting elements 1715 and electrodes 1716 can be used to transmit electrical signals to localized regions of the piezoelectric substrate 1720 to selectively actuate regions of the piezoelectric substrate 1720.

As a haptic element, the piezoelectric substrate 1720 coupled to the electrodes 1716 in the sensing layer 1713 and the ground electrode 1722 together may operate as a piezoelectric transducer. A piezoelectric transducer is actuated with an electrical signal. When activated, the piezoelectric transducer converts the electrical signal into mechanical movement, vibrations, and/or force. The mechanical movement, vibrations, and/or force generated by the actuated piezoelectric transducer is known as haptic output. When the haptic output is applied to a surface, a user can detect or feel the haptic output and perceive the haptic output as haptic feedback.

In some embodiments, portions of the piezoelectric substrate 1720 can be selectively activated. In particular, portions of the piezoelectric substrate 1720 may form individual piezoelectric transducers which can receive an electrical signal via the sensing layer 1713 independent of other portions of the piezoelectric substrate 1720 to produce localized haptic feedback.

The haptic output produced by a portion of the piezoelectric substrate 1720 can cause the layers surrounding the piezoelectric substrate 1720 to deflect or otherwise move. The deflection can transmit through the second adhesive layer 1718, the sensing layer 1713, and through the first adhesive layer 1712 to the cover sheet 1710. The transmitted deflection causes one or more sections of the cover sheet 1710 to deflect or move to provide localized haptic feedback to the user. In particular, the cover sheet 1710 bends or deflects at a location 1730 that substantially corresponds to the location of the activated portion of the piezoelectric substrate 1720.

For example, as depicted in FIG. 17, a piezoelectric transducer at a region 1728 has been activated, e.g., with an electrical signal at an electrode 1716 within the region 1728. The piezoelectric substrate 1720 expands in response to the electrical signal, producing tension T within the region 1728. While tension T may be produced pointing both upward and downward from the piezoelectric substrate 1720, the sensor structure 1705 may rest on a support structure 1732, which may resist the downward tension and cause greater upward tension.

The support structure 1732 may be made from a rigid material, such as a metal or metal alloy (e.g., stainless steel, aluminum, and so on), plastic, silicone, glass, ceramic, fiber composite, or other suitable materials, or a combination of these materials. The support structure 1732 may extend along a length and a width of the user input region 1704, although this is not required. The support structure 1732 can have any shape and/or dimensions in other embodiments. In some embodiments, the support structure may be a single structure, while in other embodiments the support structure may be an array of support structures.

Returning to the actuation of the piezoelectric substrate 1720, the tension T caused by the expansion of the piezoelectric substrate 1720 can cause transmission of a corresponding force/deflection through the second adhesive layer 1718, the sensing layer 1713, and the first adhesive layer 1712 to the cover sheet 1710. In response to the transmitted deflection, the cover sheet 1710 bends or deflects at a location 1730 that substantially corresponds to the location of the activated portion of the piezoelectric substrate 1720. The cover sheet 1710 around the deflected location 1730 may be substantially unaffected by the haptic output produced by the actuated region 1728 of the sensor structure 1705. A user can detect the local deflection of the cover sheet 1710 and perceive the deflection as localized haptic feedback.

While FIG. 17 illustrates production of localized haptic feedback with a single piezoelectric substrate 1720, in other embodiments multiple piezoelectric substrates 1720 may form separate transducers to provide localized haptic feedback. In still other embodiments a single piezoelectric substrate 1720 may be operated as a single transducer to provide non-localized haptic feedback.

FIG. 18 depicts example components of an electronic device in accordance with the embodiments described herein. The schematic representation depicted in FIG. 18 may correspond to components of the devices depicted in FIGS. 12-17, described above. However, FIG. 18 may also more generally represent other types of devices that include controllable haptic feedback elements in accordance with the embodiments described herein.

As shown in FIG. 18, a device 1800 includes a processing unit 1880 operatively connected to computer memory 1882. The processing unit 1880 may be operatively connected to the memory 1882 component via an electronic bus or bridge. The processing unit 1880 may include one or more computer processors or microcontrollers that are configured to perform operations in response to computer-readable instructions. Where incorporated into a larger device such as a laptop computer, the processing unit 1880 may be the central processing unit (CPU) of the larger device. Additionally or alternatively, the processing unit 1880 may include other processors within the device 1800 including application specific integrated chips (ASIC) and other microcontroller devices. The processing unit 1880 may be configured to perform functionality described in the examples above.

The memory 1882 may include a variety of types of non-transitory computer-readable storage media, including, for example, read access memory (RAM), read-only memory (ROM), erasable programmable memory (e.g., EPROM and EEPROM), or flash memory. The memory 1882 is configured to store computer-readable instructions, sensor values, and other persistent software elements.

In this example, the processing unit 1880 is operable to read computer-readable instructions stored on the memory 1882. The computer-readable instructions may adapt the processing unit 1880 to perform the operations or functions described above with respect to FIGS. 12-17. The computer-readable instructions may be provided as a computer-program product, software application, or the like.

The device 1800 may also include a battery 1884 that is configured to provide electrical power to the components of the device 1800. The battery 1884 may include one or more power storage cells that are linked together to provide an internal supply of electrical power. The battery 1884 may be operatively coupled to power management circuitry that is configured to provide appropriate voltage and power levels for individual components or groups of components within the device 1800. The battery 1884, via power management circuitry, may be configured to receive power from an external source, such as an AC power outlet. The battery 1884 may store received power so that the device 1800 may operate without connection to an external power source for an extended period of time, which may range from several hours to several days.

The device 1800 may also include a display 1808. The display 1808 may include a liquid crystal display (LCD), organic light emitting diode (OLED) display, electroluminescent (EL) display, electrophoretic ink (e-ink) display, or the like. If the display 1808 is an LCD or e-ink type display, the display 1808 may also include a backlight component that can be controlled to provide variable levels of display brightness. If the display 1808 is an OLED or EL type display, the brightness of the display 1808 may be controlled by modifying the electrical signals that are provided to display elements.

In some embodiments, the device 1800 includes one or more input devices 1886. The input device 1886 is a device that is configured to receive user input. The input device 1886 may include, for example, a push button, a touch-activated button, or the like. In some embodiments, the input device 1886 may provide a dedicated or primary function, including, for example, a power button, volume buttons, home buttons, scroll wheels, and camera buttons. Generally, a touch sensor and a force sensor may also be classified as input devices. However, for purposes of this illustrative example, the touch sensor and force sensor components are depicted as distinct components within the device 1800.

The device 1800 may also include a sense electrode 1817 and drive electrode 1816. The sense electrode 1817 and drive electrode 1816 may form an array of electrodes disposed in a sensing layer of a sensor structure. The sense electrodes 1817 may form columns while the drive electrodes 1816 may form rows (see FIG. 14).

The sense electrodes 1817 and drive electrodes 1816 are configured to detect the location of a finger or object on or near an input region of the device 1800. The sense electrodes 1817 and drive electrodes may further be configured to detect the location of multiple fingers or objects concurrently.

The sense electrodes 1817 and drive electrodes 1816 may be operably coupled (e.g., electrically connected) to touch sensing circuitry 1888 to form touch sensors. The touch sensing circuitry 1888 may be configured to detect and estimate the location of a touch on or near the user input region based on inputs from the sense electrodes 1817 and drive electrodes 1816. The touch sensing circuitry may further output signals or other indicia indicating the detected location of a touch. The touch sensing circuitry 1888 may also be operably coupled to the processing unit 1880. In some embodiments the touch sensing circuitry 1888 may be integrated with the processing unit 1880.

The sense electrodes 1817 and drive electrodes 1816 may also be coupled with a piezoelectric substrate (e.g., the piezoelectric substrate 1320 of FIG. 13) and a ground electrode (e.g., the ground electrode 1322 of FIG. 13) to form a force node, or an array of force nodes. The force nodes may be used to estimate the magnitude of force applied by one or multiple touches on the cover sheet.

The device 1800 may also include force sensing circuitry 1890, which may be operably coupled to the sense electrodes 1817 and drive electrodes 1816 to form a force sensor. The force sensing circuitry 1890 may be configured to detect and estimate an amount of force applied to the user input region as measured by the sense electrodes 1817 and drive electrodes 1816. In some embodiments, the force sensing circuitry 1890 may further detect a location of an applied force. The force sensing circuitry 1890 may further output signals or other indicia indicating an estimated amount of applied force. In some embodiments, the force sensing circuitry 1890 may be configured to operate using a dynamic or adjustable force threshold. The force sensing circuitry 1890 may only output signals in accordance with an applied force exceeding the force threshold. The force sensing circuitry 1890 may further be operably coupled to the processing unit 1880.

The device 1800 may also include control circuitry 1892, which may be operably connected to the sense electrodes 1817 and drive electrodes 1816 and provide control for haptic feedback using the sensor structure. The control circuitry 1892 may provide control of individual and/or groups of sense electrodes 1817 and/or drive electrodes 1816 in order to cause localized deflections in the cover sheet of the user input region. The control circuitry 1892 may provide energizing electrical signals to the sense electrodes 1817 and drive electrodes 1816, and may control the voltage, frequency, waveform, and other features of the electrical signal to provide varying feedback to a user. The control circuitry 1892 may further be operably coupled to the processing unit 1880.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not intended to be exhaustive or to limit the embodiments to the precise forms disclosed. It will be apparent to one of ordinary skill in the art that many modifications and variations are possible in view of the above teachings.

What is claimed is:

1. An electronic device, comprising:
a cover sheet;
a display positioned below the cover sheet;
a chassis positioned below the display;
an array of piezoelectric actuators positioned below and coupled to the chassis; and
a flexible circuit assembly electrically coupled to each of the array of piezoelectric actuators, comprising:
a master flexible circuit positioned along a row of piezoelectric actuators;
a first slave flexible circuit electrically coupled to the master flexible circuit and electrically coupled to a first of the array of piezoelectric actuators;
a second slave flexible circuit electrically coupled to the master flexible circuit and electrically coupled to a second of the array of piezoelectric actuators.

2. The electronic device of claim 1, further comprising control circuitry electrically coupled to the master flexible circuit and configured to generate control signals to selectively actuate the array of piezoelectric actuators.

3. The electronic device of claim 1, wherein each of the array of piezoelectric actuators comprises:
a piezoelectric substrate having a first surface and a second surface parallel to the first surface;
a first electrode formed on the first surface; and
a second electrode formed on the second surface and a portion of the first surface.

4. The electronic device of claim 3, wherein the first electrode and the second electrode are formed by at least one of vapor deposition, sputtering, printing, and roll-to-roll processing.

5. The electronic device of claim 3, wherein the first electrode and second electrode are formed by plating the piezoelectric substrate with nickel.

6. The electronic device of claim 1, wherein the master flexible circuit, the first slave flexible circuit, and the second slave flexible circuit each comprise:
a flexible substrate; and
one or more conducting traces formed on or within the flexible substrate.

7. The electronic device of claim 6, wherein the flexible substrate comprises at least one of polyimide and polyethylene terephthalate.

8. The electronic device of claim 6, wherein the one or more conducting traces comprise at least one of silver, copper, constantan, and karma.

9. The electronic device of claim 6, wherein the first slave flexible circuit comprises a first conductive trace coupled to a control signal and a second conductive trace coupled to a reference voltage.

10. The electronic device of claim 6, wherein:
the first slave flexible circuit comprises a first conductive trace coupled to a control signal; and
the chassis is coupled to a reference voltage.

11. A haptic actuator module, comprising:
a piezoelectric substrate defining a top surface and an opposing bottom surface;
a top electrode coupled to the top surface;
a bottom electrode coupled to the bottom surface; and
a control system, comprising:
a control circuit configured to generate control signals to induce a voltage across the piezoelectric substrate and cause the piezoelectric substrate to compress along a direction;
a flexible circuit electrically connected to the control circuit and at least one of the top electrode and the bottom electrode, comprising:
a master control flex connected to the control circuit;
a first slave control flex connected to the master flex and at least one of the top electrode and the bottom electrode;
a second slave control flex connected to another haptic actuator.

12. The haptic actuator module of claim 11, wherein:
a portion of the bottom electrode is deposited on the top surface of the piezoelectric substrate; and
the first slave control flex is connected to the top electrode and the bottom electrode at the top surface of the piezoelectric substrate.

13. The haptic actuator module of claim 12, wherein the first slave control flex is coupled to the top electrode and the portion of the bottom electrode by an anisotropic conductive film.

14. The haptic actuator module of claim 11, wherein:
the top electrode is electrically connected to a support structure;
the support structure is biased with a reference voltage level; and
the first slave control flex is coupled to the bottom electrode and configured to provide a control signal to the bottom electrode.

15. The haptic actuator module of claim 14, wherein the support structure is coupled to the top electrode by an isotropic conductive film.

16. The haptic actuator module of claim 11, wherein:
the first slave control flex is split at an end into a first portion and a second portion;
the first portion is coupled to the top electrode and configured to provide a control signal to the top electrode; and
the second portion is coupled to the bottom electrode and configured to provide a reference voltage level to the bottom electrode.

17. The haptic actuator module of claim 16, wherein the first portion is coupled to the top electrode by a first isotropic conductive film and the second portion is coupled to the bottom electrode by a second isotropic conductive film.

18. A method for connecting an array of piezoelectric haptic actuators to control circuitry, the method comprising:
applying an electrically conductive bonding agent to a master flex member;
aligning a first slave flex member with the master flex member;
aligning a second slave flex member with the master flex member;
bonding the first slave flex member and the second slave flex member with the master flex member;
wherein:
the master flex member is positioned along a row of slave flex members including the first slave flex member and the second slave flex member;
the master flex member is configured to provide a first control signal to the first slave flex member and a second control signal to the second slave flex member;
the first slave flex member is configured to provide the first control signal to a first piezoelectric haptic actuator; and
the second slave flex member is configured to provide the second control signal to a second piezoelectric haptic actuator.

19. The method of claim 18, wherein:
the electrically conductive bonding agent comprises a solder paste; and
the bonding the first slave flex member and the second slave flex member with the master flex member comprises heating the first slave flex member, the second slave flex member, and the master flex member.

20. The method of claim 19, wherein the heating the first slave flex member, the second slave flex member, and the master flex member comprises heating in a reflow oven.

21. The method of claim 18, wherein:
the electrically conductive bonding agent is a first electrically conductive bonding agent; and
the method further comprises:
applying a second electrically conductive bonding agent to the first slave flex member; and
bonding the first piezoelectric haptic actuator to the first slave flex member.

22. The method of claim 21, wherein:
the second electrically conductive bonding agent comprises an anisotropic conductive film; and
the bonding the first piezoelectric haptic actuator to the first slave flex member comprises placing the first piezoelectric haptic actuator on the second electrically conductive bonding agent.

23. The method of claim 18, further comprising forming the first piezoelectric haptic actuator by:
depositing a first electrode on a first side of a piezoelectric substrate; and
depositing a second electrode on a second side of the piezoelectric substrate and a portion of the first side of the piezoelectric substrate.

24. An electronic device comprising:
an enclosure;
a display positioned within the enclosure;
an input region positioned within the enclosure; and
a sensor structure positioned below the input region, comprising:
a piezoelectric substrate;
a sensing layer comprising a plurality of drive electrodes and a plurality of sense electrodes; and
a connection layer comprising a plurality of conductive elements connected to the plurality of sense electrodes by vias;
wherein:
the sensor structure is configured to detect a location of a touch within the user input region and to estimate an amount of force corresponding to the touch;
the drive electrodes and the sense electrodes are coplanar; and
the conductive elements are not coplanar with the sense electrodes.

25. The electronic device of claim 24, further comprising touch sensing circuitry operatively coupled to the sensor structure and configured to determine the location of the touch.

26. The electronic device of claim 25, further comprising force sensing circuitry operatively coupled to the sensor structure and configured to output a signal in response to the amount of force exceeding a given threshold.

27. The electronic device of claim 26, wherein the given threshold is dynamically configurable.

28. The electronic device of claim 26, wherein the touch sensing circuitry and the force sensing circuitry form a combined touch and force sensing circuitry.

29. The electronic device of claim 24, wherein the sensor structure is further configured to output haptic feedback to the input region.

30. The electronic device of claim 24, wherein the sensing layer comprises the plurality of drive electrodes arranged in rows and the plurality of sense electrodes arranged in columns.

31. The electronic device of claim 30, wherein the plurality of drive electrodes and the plurality of sense electrodes are coplanar.

32. The electronic device of claim 31, wherein;
each of the plurality of sense electrodes spans a length of a column;
two or more of the plurality of drive electrodes are disposed between pairs of sense electrodes; and
a row of drive electrodes is electrically connected together.

33. The electronic device of claim 30, wherein the plurality of drive electrodes and the plurality of sense electrodes are non-coplanar.

34. The electronic device of claim 24, wherein:
the piezoelectric substrate is a first piezoelectric substrate; and
the sensor structure further comprises a second piezoelectric substrate coplanar to the first piezoelectric substrate.

35. A method of detecting a touch and estimating an amount of force of the touch, the method comprising:
detecting the touch with a sensor structure comprising a piezoelectric substrate;
detecting an electrical response caused by compression of the piezoelectric substrate with the sensor structure;
estimating the amount of force using the electrical response; and
outputting a signal indicating the estimated amount of force.

36. The method of claim 35, further comprising determining a location of the touch with touch sensing circuitry coupled to the sensor structure.

37. The method of claim 35, wherein the outputting the signal is in response to the estimated amount of force exceeding a given threshold.

38. The method of claim 37, wherein the given threshold is a dynamic threshold.

39. A user input device, comprising:
a cover sheet comprising a user input surface; and
a sensor structure positioned below the cover sheet, comprising:
a piezoelectric substrate; and
a sensing layer comprising a plurality of electrodes;
wherein the sensor structure is configured to detect a location of a touch on the user input surface and to estimate an amount of force corresponding to the touch.

40. The user input device of claim 39, further comprising touch sensing circuitry operatively coupled to the sensor structure and configured to determine the location of the touch.

41. The user input device of claim 39, further comprising force sensing circuitry operatively coupled to the sensor structure and configured to output a signal in response to the amount of force exceeding a given threshold.

42. The user input device of claim 39, wherein the sensor structure is further configured to output haptic feedback to the user input surface.

43. The user input device of claim 39, wherein the user input device is a trackpad.

44. The user input device of claim 43, wherein the trackpad is incorporated into a laptop computer.

45. The user input device of claim 39, wherein the user input device is operatively coupled to a mobile device.

46. The user input device of claim 45, wherein the mobile device comprises a phone, a tablet, a speaker, a headphone, a mouse, or a musical instrument.

47. The user input device of claim 39, wherein the user input device is a touch- and force-sensitive keyboard.

48. The user input device of claim 40, wherein the touch sensing circuitry is configurable to define a touch-sensing region on the cover sheet.

49. The user input device of claim 48, further comprising force sensing circuitry operatively coupled to the sensor structure and configured to define a force-sensing region wherein the force sensing circuitry outputs a signal in response to the amount of force exceeding a given threshold.
